(19) United States
(12) Patent Application Publication
(10) Pub. No.: US 2024/0227614 A9
(43) Pub. Date: Jul. 11, 2024

(54) VERIFICATION METHOD, VERIFICATION DEVICE, VERIFICATION SYSTEM, PROGRAM AND COMPUTER READABLE MEDIUM

(71) Applicant: HONDA MOTOR CO.,LTD., Tokyo (JP)

(72) Inventor: Hironori HARADA, Saitama (JP)

(21) Appl. No.: 18/547,699

(22) PCT Filed: Feb. 24, 2022
(86) PCT No.: PCT/JP2022/007553

§ 371 Date: Aug. 24, 2023

(30) Foreign Application Priority Data
Feb. 25, 2021 (JP) 2021-029272

(51) Int. Cl. B60L 53/66

(52) U.S. Cl. CPC B60L 53/66

(57) ABSTRACT

A confirmation method has: converting first information based on second information to generate third information; transmitting the third information to the to-be-confirmed apparatus; receiving, from the to-be-confirmed apparatus, (i) fifth information generated through inverse conversion, by the to-be-confirmed apparatus, of the third information based on fourth information paired with the second information or (ii) sixth information generated through information processing, by the to-be-confirmed apparatus, on the fifth information according to a predetermined first algorithm; and (a) comparing the first information with the fifth information if the fifth information is received, or (b) if the sixth information is received, (i) comparing seventh information to be generated through information processing on the first information according to the first algorithm with the sixth information or (ii) comparing the first information with eighth information to be generated through information processing on the sixth information according to a second algorithm related to the first algorithm.

### BACKGROUND

### 1. Technical Field

The present invention relates to a confirmation method, a confirmation apparatus, a confirmation system, a program, and a computer readable storage medium.

### 2. Related Art

Patent Document 1 discloses a management device which authenticates a battery by collating an authentication key stored in a battery to be returned to a battery station with an authentication key stored in the battery station. Patent Document 2 discloses a battery station which judges, by using a whitelist method, whether a battery can be received.

### PRIOR ART DOCUMENTS

### Patent Document

Patent Document 1: WO 2019/181661
Patent Document 2: WO 2020/059833

### GENERAL DISCLOSURE

A first aspect of the present invention provides a confirmation method. The above-described confirmation method is, for example, a method for confirming, by a confirmation apparatus, whether a to-be-confirmed apparatus is a legitimate apparatus. The above-described confirmation method has, for example, converting first information based on second information to generate third information. The above-described confirmation method has, for example, transmitting the third information to the to-be-confirmed apparatus. The above-described confirmation method has, for example, receiving, from the to-be-confirmed apparatus, (i) fifth information generated through inverse conversion, by the to-be-confirmed apparatus, of the third information based on fourth information paired with the second information or (ii) sixth information generated through information processing, by the to-be-confirmed apparatus, on the fifth information in accordance with a predetermined first algorithm. The above-described confirmation method has, for example, (a) comparing the first information with the fifth information if the fifth information is received, or (b) if the sixth information is received, (i) comparing seventh information to be generated through information processing on the first information in accordance with the first algorithm with the sixth information or (ii) comparing the first information with eighth information to be generated through information processing on the sixth information in accordance with a second algorithm related to the first algorithm.

In the above-described confirmation method, the first algorithm may be an algorithm relating to arithmetic processing using a first function, or an algorithm relating to encryption processing using a ninth information. In the above-described confirmation method, the second algorithm may be an algorithm relating to arithmetic processing using a second function which is an inverse function of the first function, or an algorithm relating to decryption processing using the ninth information or tenth information paired with the ninth information.

The above-described confirmation method may have (i) obtaining the second information from a manufacturer or a transferor of the confirmation apparatus or from an issuer of the second information and the fourth information or (ii) obtaining the second information from a first external apparatus which is configured to be able to wirelessly communicate with the confirmation apparatus and which has confirmed that the confirmation apparatus is legitimate. The above-described confirmation method may have storing the second information which has been obtained in a first storage apparatus arranged in the confirmation apparatus. The above-described confirmation method may have receiving, from the to-be-confirmed apparatus, eleventh information and thirteenth information generated through conversion of the eleventh information based on twelfth information. The above-described confirmation method may have comparing fifteenth information to be generated by inversely converting the thirteenth information based on fourteenth information paired with the twelfth information with the eleventh information. The above-described confirmation method may have obtaining the eleventh information as the second information if the eleventh information and the fifteenth information match.

The above-described confirmation method may have determining whether the to-be-confirmed apparatus is the legitimate apparatus, based on a result of comparing the first information and the fifth information, a result of comparing the sixth information and the seventh information, or a result of comparing the first information and the eighth information. The above-described confirmation method may have confirming that the to-be-confirmed apparatus is not legitimate or that the to-be-confirmed apparatus is illegitimate, if the first information and the fifth information do not match, the sixth information and the seventh information do not match, or the first information and the eighth information do not match.

In the above-described confirmation method, the second information may be a public key. In addition, the fourth information may be a private key corresponding to the public key. The above-described confirmation method may have generating a random number. The above-described confirmation method may have generating the first information based on the random number. In the above-described confirmation method, the to-be-confirmed apparatus may include an electricity accumulation apparatus. In the above-described confirmation method, the confirmation apparatus may include a charging apparatus which is configured to be freely attached to and detached from the electricity accumulation apparatus of the to-be-confirmed apparatus and which charges the electricity accumulation apparatus.

The above-described confirmation method may have receiving, by the to-be-confirmed apparatus, the third information from the confirmation apparatus. The above-described confirmation method may have generating, by the to-be-confirmed apparatus, the fifth information based on the third information and the fourth information. The above-described confirmation method may have transmitting, by the to-be-confirmed apparatus, the fifth information which has been generated to the confirmation apparatus. The above-described confirmation method may have (i) obtaining the fourth information from a manufacturer or a transferor of the to-be-confirmed apparatus or from an issuer of the second information and the fourth information or (ii) obtaining the fourth information from a second external apparatus which is configured to be able to wirelessly communicate with the to-be-confirmed apparatus and which has confirmed that the to-be-confirmed apparatus is legitimate. The above-described confirmation method may have storing the fourth information which has been obtained in a second storage apparatus arranged in the to-be-confirmed apparatus.

The above-described confirmation method may have (i) obtaining the second information and the fourth information from a manufacturer or a transferor of the to-be-confirmed apparatus or from an issuer of the second information and the fourth information or (ii) obtaining the second information and the fourth information from a second external apparatus which is configured to be able to wirelessly communicate with the to-be-confirmed apparatus and which has confirmed that the to-be-confirmed apparatus is legitimate. The above-described confirmation method may have converting, based on the twelfth information, the second information which has been obtained, to generate the thirteenth information. The above-described confirmation method may have transmitting the thirteenth information which has been generated to the confirmation apparatus. The above-described confirmation method may have transmitting the second information as the eleventh information to the confirmation apparatus.

In the above-described confirmation method, the confirmation apparatus may be a preservation apparatus which preserves the to-be-confirmed apparatus as a to-be-preserved apparatus. The preservation apparatus may have an attachment part to which the to-be-preserved apparatus is attached. In the above-described confirmation method, the confirmation method may have deciding not to attach the to-be-preserved apparatus to the attachment part, if the first information and the fifth information do not match, the sixth information and the seventh information do not match, or the first information and the eighth information do not match.

In the above-described confirmation method, the preservation apparatus may be configured to be able to preserve at least one of a plurality of to-be-preserved apparatuses including the to-be-preserved apparatus. In the above-described confirmation method, the confirmation method may have obtaining joint use identification information for identifying the to-be-preserved apparatus which can be jointly used by a plurality of customers, among the plurality of to-be-preserved apparatuses. In the above-described confirmation method, the confirmation method may have determining whether the to-be-confirmed apparatus is the to-be-preserved apparatus which can be jointly used by the plurality of customers, based on the joint use identification information, if the first information and the fifth information match, the sixth information and the seventh information match, or the first information and the eighth information match. In the above-described confirmation method, the confirmation method may have deciding not to attach the to-be-preserved apparatus to the attachment part, if it is determined that the to-be-confirmed apparatus is not the to-be-preserved apparatus which can be jointly used by the plurality of customers.

In the above-described confirmation method, the confirmation apparatus may be a first electric power apparatus having a first terminal. In the above-described confirmation method, the to-be-confirmed apparatus may be a second electric power apparatus having a second terminal configured to be able to be attached to the first terminal. In the above-described confirmation method, the confirmation method may have deciding to prohibit or suppress output and input of electric power between the first electric power apparatus and the second electric power apparatus, if the first information and the fifth information do not match, the sixth information and the seventh information do not match, or the first information and the eighth information do not match.

A second aspect of the present invention provides a confirmation apparatus. The above-described confirmation apparatus confirms whether a to-be-confirmed apparatus is a legitimate apparatus, for example. The above-described confirmation apparatus includes, for example, a third information generation unit which converts first information based on second information to generate third information. The above-described confirmation apparatus includes, for example, a third information transmission unit which transmits the third information to the to-be-confirmed apparatus. The above-described confirmation apparatus includes, for example, a response reception unit which receives, from the to-be-confirmed apparatus, (i) fifth information generated through inverse conversion, by the to-be-confirmed apparatus, of the third information based on fourth information paired with the second information or (ii) sixth information generated through information processing, by the to-be-confirmed apparatus, on the fifth information in accordance with a predetermined first algorithm. The above-described confirmation apparatus includes, for example, a comparison unit which (a) compares the first information with the fifth information if the fifth information is received, or (b) if the sixth information is received, (i) compares seventh information to be generated through information processing on the first information in accordance with the first algorithm with the sixth information or (ii) compares the first information with eighth information to be generated through information processing on the sixth information in accordance with a predetermined second algorithm.

A third aspect of the present invention provides an electricity accumulation apparatus. The above-described electricity accumulation apparatus includes, for example, an electricity accumulation unit which accumulates electrical energy. The above-described electricity accumulation apparatus include, for example, an electrical terminal for transmitting and receiving electric power to and from a first electric power apparatus which charges the electricity accumulation unit or uses electric power discharged by the electricity accumulation unit. The above-described electricity accumulation apparatus include, for example, a storage unit which stores fourth information. The above-described electricity accumulation apparatus includes, for example, a third information obtainment unit which obtains third information from the first electric power apparatus. The above-described electricity accumulation apparatus include, for example, a fifth information generation unit which generates fifth information by inversely converting the third information obtained by the third information obtainment unit, based on the fourth information stored in the storage unit. The above-described electricity accumulation apparatus includes, for example, a response unit which transmits, to the first electric power apparatus, the fifth information, or sixth information to be generated through information processing on the fifth information in accordance with a predetermined first algorithm.

A fourth aspect of the present invention provides a confirmation system. The above-described confirmation system includes, for example, an electricity accumulation apparatus. The above-described confirmation system may include the electricity accumulation apparatus according to the third aspect described above. The above-described confirmation system includes, for example, an electric power apparatus. The above-described confirmation system may include an electric power apparatus having the confirmation apparatus according to the second aspect described above. In the above-described confirmation system, for example, the confirmation apparatus confirms that the electricity accumulation apparatus as a to-be-confirmed apparatus is a legitimate apparatus.

The fifth aspect of the present invention provides a program. The above-described program may be a program that causes a computer to execute the confirmation method according to the first aspect described above. The above-described program may be a program that causes the computer to function as the confirmation apparatus according to the second aspect described above. The above-described program may be a program that causes the computer to function as the electricity accumulation apparatus according to the third aspect described above.

A sixth aspect of the present invention provides a computer readable storage medium. The above-described computer readable storage medium stores, for example, the program according to the fifth aspect described above. The above-described computer readable storage medium may be a non-transitory computer readable medium.

Note that the above-described summary clause does not necessarily describe all necessary features of the embodiments of the present invention. In addition, the invention may also be a sub-combination of the features described above.

### BRIEF DESCRIPTION OF THE DRAWINGS

FIG. 1 schematically shows an example of a system configuration of a battery management system 100.

FIG. 2 schematically shows an example of an internal configuration of a mobile battery 20.

FIG. 3 schematically shows an example of an internal configuration of a battery station 120.

FIG. 4 schematically shows an example of a procedure for authenticating the mobile battery 20.

FIG. 5 schematically shows an example of an internal configuration of a battery authentication unit 378.

FIG. 6 schematically shows an example of an internal configuration of an authentication handling unit 232.

FIG. 7 schematically shows an example of an internal configuration of on-board equipment 330.

FIG. 8 schematically shows an example of an internal configuration of on-board equipment 370.

FIG. 9 schematically shows an example of an internal configuration of a mobile battery 920.

FIG. 10 schematically shows an example of a procedure for obtaining an authentication public key 74.

FIG. 11 schematically shows an example of the procedure for obtaining the authentication public key 74.

FIG. 12 schematically shows an example of an internal configuration of a computer 3000.

### DESCRIPTION OF EXEMPLARY EMBODIMENTS

Hereinafter, the present invention will be described through embodiments of the invention, but the following embodiments do not limit the invention according to claims. In addition, not all of the combinations of features described in the embodiments are essential to the solution of the invention. Note that in the drawings, the same or similar parts are assigned with the same reference numbers, and duplicated description may be omitted.

(Overview of a Battery Management System 100)

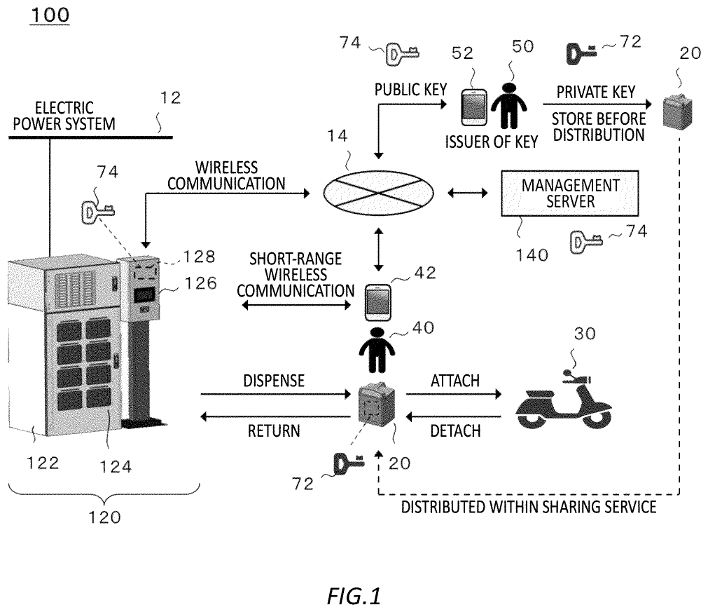

FIG. 1 schematically shows an example of a system configuration of the battery management system 100. In the present embodiment, the battery management system 100 includes one or a plurality of (may be simply referred to as one or more) battery stations 120 and a management server 140. In the present embodiment, the battery station 120 has one or more preservation units 122 and a communication unit 126. In the present embodiment, the preservation unit 122 includes one or more slots 124. In the present embodiment, the communication unit 126 includes a communication interface 128.

In the present embodiment, each unit of the battery management system 100 works by consuming electric power received from an electric power system 12. In addition, each unit of the battery management system 100 can transmit and receive information to and from each other via a communication network 14. The one or more preservation units 122 and the communication unit 126 can transmit and receive information to and from each other via a wired or wireless communication line (not shown).

In the present embodiment, the battery management system 100 manages one or a plurality of (may be referred to as one or more) mobile batteries 20. For ease of explanation, in the present embodiment, the battery management system 100 will be described in detail by taking as an example a case where the battery management system 100 provides a sharing service of the mobile battery 20 to a user 40 of an electric motorcycle 30.

In the present embodiment, each of the one or more slots 124 arranged in the preservation unit 122 of the battery station 120 can preserve one or more mobile batteries 20. In addition, each of the one or more slots 124 arranged in the preservation unit 122 of the battery station 120 can charge the one or more mobile batteries 20.

The user 40 who has subscribed to the sharing service of the mobile battery 20 accesses the battery management system 100 by using, for example, a communications terminal 42, and requests lending/renting of the mobile battery 20. The user 40 may designate a date and time and a place at which the user wishes the lending/renting of the mobile battery 20 as well as the number of mobile batteries 20 the lending/renting of which the user wishes, to make a reservation for the lending/renting of the mobile battery 20. The communications terminal 42 may access the battery management system 100 via the communication network 14 or may access the battery management system 100 via the battery station 120. Note that the user 40 may operate the battery station 120 to request the lending/renting of the mobile battery 20.

When the above-described request is accepted, the user 40 can take out the mobile battery 20 accommodated in the battery station 120 (may be referred to as dispensation of the mobile battery 20). This allows the user 40 to replace the mobile battery 20 attached to the electric motorcycle 30 with the mobile battery 20 accommodated in the battery station 120.

More specifically, the user 40 removes the mobile battery 20 attached to the electric motorcycle 30 from the electric motorcycle 30. The user 40 returns the mobile battery 20 removed from the electric motorcycle 30 to the battery station 120. When the user 40 returns the mobile battery 20, the battery station 120 dispenses the mobile battery 20 which has been charged and accommodated in the battery station 120. The user 40 receives the charged mobile battery 20 from the battery station 120 and attaches that charged mobile battery 20 to the electric motorcycle 30. As such, the mobile batteries 20 are exchanged between the electric motorcycle 30 and the battery station 120.

(Authentication of the Mobile Battery 20 in the Battery Management System 100)

In the present embodiment, the battery station 120 may be arranged in a lockable building or site or may be arranged outdoors in an unlocked state. In light of convenience for the user 40, the battery station 120 is preferably arranged in an environment where many users 40 can freely use it. On the other hand, when the battery station 120 is arranged in the environment where many users 40 can freely use it, there is a possibility that the mobile battery 20 which is not under control of the battery management system 100 (may be referred to as an illegitimate mobile battery 20) is inserted into the slot 124 of the battery station 120.

When the illegitimate mobile battery 20 having a different specification from that of a legitimate mobile battery 20 is inserted into the slot 124 and an electrical terminal of that illegitimate mobile battery 20 and an electrical terminal of the slot 124 are attached to each other, there is a possibility that a usage condition of the illegitimate mobile battery 20 departs from an appropriate range. In addition, since the battery station 120 is used by many users 40, there is also a possibility that the above-described illegitimate mobile battery 20 is dispensed to another user 40 different from the user 40 who has inserted the illegitimate mobile battery 20 to the slot 124.

The illegitimate mobile battery 20 is not limited to the mobile battery 20 having a different specification from that of the mobile battery 20 which is under control of the battery management system 100 (may be referred to as the legitimate mobile battery 20). The illegitimate mobile battery 20 may have the same specification as that of the legitimate mobile battery 20 or may have a specification conforming to the legitimate mobile battery 20.

For example, in a case where the user 40 of the electric motorcycle 30 has purchased the mobile battery 20, if the user 40 has not subscribed to a charging service of the mobile battery 20 or a replacement service of the mobile battery 20 by the battery management system 100, the mobile battery 20 purchased by the user 40 is treated as the illegitimate mobile battery 20 having the same specification as that of the legitimate mobile battery 20. According to the present embodiment, the battery management system 100 manages a deterioration state of the legitimate mobile battery 20 and maintains or replaces the mobile battery 20 at appropriate timing. This allows the user 40 to safely use the mobile battery 20. In addition, the mobile battery 20 with less deterioration is provided, which improves a usage experience of the user 40.

On the other hand, the battery management system 100 cannot grasp a state of maintenance and management of the illegitimate mobile battery 20. Therefore, if the mobile battery 20 insufficiently maintained and managed is mixed in with the mobile batteries 20 preserved in the battery station 120, there is a possibility that the usage experience of the user 40 is degraded. Therefore, according to the present embodiment, when the mobile battery 20 is attached to the slot 124, the battery station 120 executes authentication processing on the mobile battery 20.

Possible techniques for authenticating the mobile battery 20 include (i) a technique which, by the electric motorcycle 30 or the battery station 120, obtains identification information of the mobile battery 20 to be authenticated (may be referred to as a battery ID) and collates the battery ID of the mobile battery 20 to be authenticated with a list of battery IDs of the legitimate mobile batteries 20 (may be referred to as a whitelist), (ii) a technique which authenticates, by the electric motorcycle 30 or the battery station 120, the mobile battery 20 by transmitting and receiving an authentication code by using a common key cryptosystem, and the like.

However, according to the above-described techniques, it is difficult to effectively suppress leakage of the battery IDs or the like due to eavesdropping, repeat attack, or the like. For example, if the mobile battery 20 is authenticated by using the whitelist of the battery IDs, the leakage of the battery IDs registered in the whitelist makes it difficult to suppress a counterfeit product of the mobile battery 20 from being distributed. In addition, if the mobile battery 20 is authenticated with the common key cryptosystem, leakage of a common key makes it difficult to suppress the counterfeit product of the mobile battery 20 from being distributed. Particularly, if a plurality of batteries share the same common key, damage caused by counterfeiting will increase.

Therefore, in the present embodiment, the battery management system 100 authenticates the mobile battery 20 with a public key cryptosystem. This allows the battery management system 100 to confirm whether the mobile battery 20 attached to the slot 124 is the legitimate mobile battery 20 while solving the above-described issue.

In addition, according to the present embodiment, the battery station 120 authenticates the mobile battery 20 with the public key cryptosystem. A known method may be adopted as the public key cryptosystem. Examples of cryptography of the public key cryptosystem include RSA cryptography, elliptic curve cryptography, and the like.

Since a processor mounted on the mobile battery 20 or the electric motorcycle 30 has relatively low arithmetic performance, it is difficult for the mobile battery 20 or the electric motorcycle 30 to execute a complicated arithmetic operation. On the other hand, the battery station 120 can be equipped with a processor having higher arithmetic capacity than the processor mounted on the mobile battery 20 or the electric motorcycle 30. The public key cryptosystem has a larger computational load than the common key cryptosystem. Therefore, if the mobile battery 20 is authenticated with the public key cryptosystem, a processor executing that authentication processing is required to execute the complicated arithmetic operation at a high speed. In this respect, the battery station 120 can authenticate the mobile battery 20 with the public key cryptosystem by using a high performance processor.

Specifically, first, a key issuer 50 issues a pair of an authentication private key 72 and an authentication public key 74 for each of the one or more mobile batteries 20. The key issuer 50 may be a manufacturer or a transferor of the mobile battery 20, may be a manufacturer or a transferor of the battery station 120, or may be an administrator or an operator of the battery management system 100. The key issuer 50 may be a natural person, may be a legal entity, may be an organization, or may be an employee of that legal entity or a staff member of that organization, or the like. The key issuer 50 may issue the pair of the authentication private key 72 and the authentication public key 74 by using a communications terminal 52.

Next, the key issuer 50 causes respective storage apparatuses (not shown) of the one or more mobile batteries 20 to store respective authentication private keys 72 of the one or more mobile batteries 20. In one embodiment, the key issuer 50 communicably connects the communications terminal 52 and the mobile battery 20 and causes the authentication private key 72 corresponding to the mobile battery 20 connected to the communications terminal 52 to be transmitted from the communications terminal 52 to the mobile battery 20. The communications terminal 52 and the mobile battery 20 may transmit and receive information through wired communication or may transmit and receive information through wireless communication. In another embodiment, the key issuer 50 may input the authentication private key 72 into an input apparatus arranged in the mobile battery 20 or may attach the storage apparatus storing the authentication private key 72 to the mobile battery 20.

In addition, the key issuer 50 causes the respective storage apparatuses (not shown) of the one or more battery stations 120 to store respective authentication public keys 74 of the one or more mobile batteries 20. In one embodiment, the key issuer 50 puts the respective authentication public keys 74 of the one or more mobile batteries 20 into a state where each of the one or more battery stations 120 can obtain them. For example, the key issuer 50 operates the communications terminal 52 to make setting such that each of the one or more battery stations 120 can access a database which associates and stores the battery ID and the authentication public key 74 for each of the one or more mobile batteries 20. The above-described database may be stored in the communications terminal 52 or may be stored in the management server 140.

In another embodiment, the key issuer 50 communicably connects the communications terminal 52 and the battery station 120 and causes the above-described database to be transmitted from the communications terminal 52 to the battery station 120. The communications terminal 52 and the battery station 120 may transmit and receive information through the wired communication or may transmit and receive information through the wireless communication. In yet another embodiment, the key issuer 50 may input the above-described database from an input apparatus arranged in the battery station 120 or may attach the storage apparatus storing the above-described database to the battery station 120. The above-described database is stored in the storage apparatus of the battery station 120 when the battery station 120 is manufactured, shipped, transferred, or placed. In addition, the above-described database may be appropriately updated.

In this state, when the user 40 inserts the mobile battery 20 into the slot 124 of the battery station 120 and the mobile battery 20 is attached to the slot 124, the battery station 120 first obtains the battery ID of the mobile battery 20 attached to the slot 124. The battery station 120 may obtain the battery ID of the mobile battery 20 from the mobile battery 20 or may obtain the battery ID of the mobile battery 20 from the communications terminal 42.

Next, the battery station 120 obtains the authentication public key 74 of the mobile battery 20 attached to the slot 124, based on the above-described battery ID. In one embodiment, the battery station 120 uses the above-described battery ID as a key to refer to the above-described database stored in the storage apparatus of the battery station 120, and obtains the authentication public key 74 of the mobile battery 20 attached to the slot 124. In another embodiment, the battery station 120 accesses the communications terminal 52 or the management server 140, uses the above-described battery ID as a key to refer to the above-described database stored in the communications terminal 52 or the management server 140, and obtains the authentication public key 74 of the mobile battery 20 attached to the slot 124.

Next, the battery station 120 prepares a code (may be referred to as an authentication code) for authenticating the mobile battery 20 attached to the slot 124. The authentication code may be a combination of numbers, letters, and symbols. The authentication code may be image data or may be voice data. The authentication code may be generated each time authentication is performed or may be generated each time a predetermined validity period elapses. The authentication code may be a code predetermined for each of the mobile batteries 20. The battery station 120, for example, generates a random number each time authentication processing is executed, and use that random number as the authentication code.

Next, the battery station 120 converts the authentication code based on the authentication public key 74 of the mobile battery 20 attached to the slot 124. Specifically, the battery station 120 encrypts the authentication code by using the authentication public key 74 of the mobile battery 20 attached to the slot 124. As such, a challenge code including the encrypted authentication code is generated.

The battery station 120 transmits the generated challenge code to the mobile battery 20 and requests a response to that challenge code. Examples of the response to the challenge code include transmitting a response code including information indicating that the mobile battery 20 has successfully decrypted the authentication code encrypted with the authentication public key 74.

Examples of the information indicating that the mobile battery 20 has successfully decrypted the authentication code encrypted with the authentication public key 74 include (i) the decrypted authentication code, (ii) information generated through information processing on the decrypted authentication code in accordance with a predetermined algorithm (may be referred to as a first algorithm), and the like. Examples of the first algorithm include an algorithm relating to arithmetic processing using a predetermined function (may be referred to as a first function), an algorithm relating to encryption processing using predetermined information, and the like. Examples of the above-described function include a hash function.

The above-described encryption processing may be common key system encryption processing using a common key or may be public key system encryption processing using a public key and a private key. Examples of the public key system encryption processing include the above-described RSA cryptography, elliptic curve cryptography, and the like.

When the mobile battery 20 receives the challenge code and a request for the response (may be referred to as an authentication response request) to the challenge code, the authentication private key 72 of the mobile battery 20 is used to decrypt the authentication code encrypted with the authentication public key 74. When the mobile battery 20 has successfully decrypted the authentication code encrypted with the authentication public key 74, the decrypted authentication code is obtained. This allows the mobile battery 20 to generate the decrypted authentication code, by using the challenge code or the authentication code encrypted with the authentication public key 74 included in that challenge code, and the authentication private key 72 of the mobile battery 20.

Next, the mobile battery 20 generates the response code in accordance with a predetermined rule. The above-described rule may be information indicating a type of or a procedure for generating, the information indicating that the mobile battery 20 has successfully decrypted the authentication code encrypted with the authentication public key 74. In addition, the mobile battery 20 transmits the generated response code to the battery station 120 as the response to the authentication response request.

In one embodiment, the above-described rule indicates that the decrypted authentication code is used as the information indicating that the mobile battery 20 has successfully decrypted the authentication code encrypted with the authentication public key 74. In this case, the mobile battery 20 generates the response code including the decrypted authentication code.

In another embodiment, the above-described rule indicates that information to be generated by performing the information processing on the decrypted authentication code in accordance with the first algorithm (may be referred to as a first processing value of the decrypted authentication code) is used as the information indicating that the mobile battery 20 has successfully decrypted the authentication code encrypted with the authentication public key 74. In this case, the mobile battery 20 generates the above-described first processing value by performing the information processing on the decrypted authentication code in accordance with the first algorithm. In addition, the mobile battery 20 generates the response code including the above-described first processing value. Use of the response code including the above-described first processing value may suppress leakage of the authentication code due to the eavesdropping, the repeat attack, or the like, inverse analysis of an authentication algorithm, or the like.

For example, if the first algorithm is an algorithm relating to arithmetic processing using the hash function, the mobile battery 20 generates the response code including a hash value of the decrypted authentication code. If the first algorithm is the common key system encryption processing using the common key, the mobile battery 20 generates the response code including a ciphertext obtained by encrypting the decrypted authentication code by using the common key. If the first algorithm is the public key system encryption processing using the public key and the private key, the mobile battery 20 generates the response code including a ciphertext obtained by encrypting the decrypted authentication code by using the private key or the public key.

Next, the battery station 120 receives the response code which is from the mobile battery 20. The battery station 120 confirms that the mobile battery 20 has successfully decrypted the authentication code encrypted with the authentication public key 74, based on the above-described response code.

In one embodiment, if the above-described response code includes the decrypted authentication code, the battery station 120 compares the authentication code generated by the battery station 120 with the authentication code included in the response code. In addition, the battery station 120 confirms whether the mobile battery 20 has successfully decrypted the authentication code encrypted with the authentication public key 74, based on a result of the comparison. This allows the battery station 120 to confirm whether the mobile battery 20 attached to the slot 124 is the legitimate mobile battery 20.

For example, if the authentication code generated by the battery station 120 matches the restored authentication code included in the response code, the battery station 120 confirms that the mobile battery 20 attached to the slot 124 is the legitimate mobile battery 20. On the other hand, if the authentication code generated by the battery station 120 does not match the restored authentication code included in the response code, the battery station 120 confirms that the mobile battery 20 attached to the slot 124 is not the legitimate mobile battery 20 or that the mobile battery 20 attached to the slot 124 is the illegitimate mobile battery 20.

In another embodiment, if the above-described response code includes the first processing value of the decrypted authentication code, the battery station 120 compares information to be generated by performing information processing on the authentication code generated by the battery station 120 in accordance with the first algorithm (may be referred to as the first processing value of the authentication code generated by the battery station 120) with the first processing value of the decrypted authentication code included in the response code. In addition, the battery station 120 confirms whether the mobile battery 20 has successfully decrypted the authentication code encrypted with the authentication public key 74, based on a result of the comparison. This allows the battery station 120 to confirm whether the mobile battery 20 attached to the slot 124 is the legitimate mobile battery 20.

For example, if the first processing value of the authentication code generated by the battery station 120 matches the first processing value of the restored authentication code included in the response code, the battery station 120 confirms that the mobile battery 20 attached to the slot 124 is the legitimate mobile battery 20. On the other hand, if the first processing value of the authentication code generated by the battery station 120 does not match the first processing value of the restored authentication code included in the response code, the battery station 120 confirms that the mobile battery 20 attached to the slot 124 is not the legitimate mobile battery 20 or that the mobile battery 20 attached to the slot 124 is the illegitimate mobile battery 20.

In yet another embodiment, if the above-described response code includes the first processing value of the decrypted authentication code, the battery station 120 compares the authentication code generated by the battery station 120 with information to be generated by performing information processing on the first processing value of the decrypted authentication code included in the response code in accordance with the second algorithm (may be referred to as a second processing value of the restored authentication code). In addition, the battery station 120 confirms whether the mobile battery 20 has successfully decrypted the authentication code encrypted with the authentication public key 74, based on a result of the comparison. This allows the battery station 120 to confirm whether the mobile battery 20 attached to the slot 124 is the legitimate mobile battery 20.

The second algorithm may be an algorithm relating to arithmetic processing using a second function which is an inverse function of the first function, or an algorithm relating to decryption processing for decrypting information encrypted through encryption processing of the first algorithm. The above-described decryption processing may be decryption processing using key information used for encryption of the first algorithm or key information paired with that key information.

For example, if the authentication code generated by the battery station 120 matches the second processing value of the restored authentication code included in the response code, the battery station 120 confirms that the mobile battery 20 attached to the slot 124 is the legitimate mobile battery 20. On the other hand, if the authentication code generated by the battery station 120 does not match the second processing value of the restored authentication code included in the response code, the battery station 120 confirms that the mobile battery 20 attached to the slot 124 is not the legitimate mobile battery 20 or that the mobile battery 20 attached to the slot 124 is the illegitimate mobile battery 20.

As described above, the battery station 120 can confirm that the mobile battery 20 is the legitimate mobile battery 20, while effectively suppressing the leakage of the authentication code. In addition, the battery station 120 can confirm that the mobile battery 20 attached to the slot 124 is not the legitimate mobile battery 20 or that the mobile battery 20 attached to the slot 124 is the illegitimate mobile battery 20, while effectively suppressing the leakage of the authentication code.

As described above, the battery station 120 is configured to allow the replacement of the mobile batteries 20. Therefore, the battery station 120 may determine whether to replace the mobile battery 20, based on a result of the above-described confirmation. The battery station 120 may determine whether to replace the mobile battery 20, based on information for identifying the mobile battery 20 which can be jointly used by a plurality of mobile batteries 20 (may be referred to as a whitelist), among the plurality of mobile batteries 20. The battery station 120 may determine whether to replace the mobile battery 20, based on the result of the above-described confirmation and the whitelist.

Similarly, the battery station 120 is configured to be able to charge or discharge the mobile battery 20. Therefore, the battery station 120 may determine whether to charge or discharge the mobile battery 20, based on the result of the above-described confirmation. The battery station 120 may determine whether to charge or discharge the mobile battery 20, based on the whitelist. The battery station 120 may determine whether to charge or discharge the mobile battery 20, based on the result of the above-described confirmation and the whitelist.

(Overview of Each Unit Related to the Battery Management System 100)

In the present embodiment, the communication network 14 conveys information. The communication network 14 may be a transmission path for the wired communication, or may be a transmission path for the wireless communication, or may be a combination of the transmission path for the wireless communication and the transmission path for the wired communication. The communication network 14 may include a wireless packet communication net, the Internet, a P2P network, a dedicated line, VPN, an electric power line communication line, and the like.

The communication network 14 may include (i) a mobile communication net such as a mobile phone line network or may include (ii) a wireless communication net such as a wireless MAN (for example, a WiMAX (registered trademark)), a wireless LAN (for example, a WiFi (registered trademark), Bluetooth (registered trademark), a Zigbee (registered trademark), and an NFC (Near Field Communication). The wireless LAN, Bluetooth (registered trademark), Zigbee (registered trademark), and NFC may be examples of short-range wireless communication.

In the present embodiment, the mobile battery 20 accumulates electrical energy. The mobile battery 20 may be configured to be able to be attached to and detached from (may be referred to as freely attached to and detached from) the electric motorcycle 30. The mobile battery 20 may be configured to be able to be attached to and detached from the battery station 120. This allows the user 40 to replace the mobile battery 20 attached to the electric motorcycle 30 with the mobile battery 20 accommodated in the battery station 120.

In one embodiment, the mobile battery 20 is attached to the electric motorcycle 30 and supplies electric power to the electric motorcycle 30. As described above, the mobile battery 20 may be detachably attached to the electric motorcycle 30. In another embodiment, the mobile battery 20 is charged by the battery station 120 while being accommodated in the battery station 120.

Note that the mobile battery 20 may supply electric power to the battery station 120 while being accommodated in the battery station 120. This allows the battery station 120 to use some of the mobile batteries 20 accommodated in the battery station 120 as, for example, an uninterruptible power system (may be referred to as a UPS).

In the present embodiment, the mobile battery 20 stores the authentication private key 72. The authentication private key 72 may be stored in any type of storage apparatus (not shown) arranged in the mobile battery 20. The mobile battery 20 may store a variety of keys used for a variety of encryption processing and/or decryption processing executed with the battery station 120. Examples of the above-described key include a private key for an electronic signature, a public key for the electronic signature (may be referred to as an electronic certificate), and the like.

In the present embodiment, the electric motorcycle 30 is equipped with the mobile battery 20. The electric motorcycle 30 may be equipped with the plurality of mobile batteries 20. The electric motorcycle 30 uses electric power accumulated in the mobile battery 20. For example, the electric motorcycle 30 runs by consuming the electric power supplied from the mobile battery 20.

In the present embodiment, the communications terminal 42 transmits and receives information to and from each unit of the battery management system 100 via the communication network 14. The communications terminal 42 may function as a user interface for a case where the user 40 accesses the battery management system 100. The communications terminal 42 may be used for user authentication processing performed by the battery management system 100.

Examples of the communications terminal 42 include a personal computer, a portable terminal, and the like. Examples of the portable terminal include a mobile phone, a smartphone, a PDA, a tablet, a notebook computer or a laptop computer, a wearable computer, and the like.

In the present embodiment, the communications terminal 52 transmits and receives information to and from each unit of the battery management system 100 via the communication network 14. The communications terminal 52 may function as a user interface for a case where the key issuer 50 accesses the battery management system 100.

The communications terminal 52 may be used for generation processing on a variety of keys such as the authentication private key 72 or the authentication public key 74. The communications terminal 52 may store the generated authentication private key 72 in the storage apparatus of the mobile battery 20 corresponding to that key. After the authentication private key 72 is stored in the mobile battery 20, the communications terminal 52 may erase the authentication private key 72 from a storage apparatus of the communications terminal 52. The communications terminal 52 may store the generated authentication public key 74 in the storage apparatuses of the one or more battery stations 120. The communications terminal 52 may have a database which associates and stores the battery ID and the above-described variety of public keys for each of the one or more mobile batteries 20. The above-described database may associate and store respective battery IDs of the one or more mobile batteries 20 and the respective authentication public keys 74 of the one or more mobile batteries 20.

The communications terminal 52 may be configured to be able to wirelessly communicate with the one or more battery stations 120. The communications terminal 52 may be an information processing apparatus which has confirmed that at least one of the one or more battery stations 120 is legitimate. The communications terminal 52 may be a reliable information processing apparatus for the one or more battery stations 120. The communications terminal 52 may be configured to be able to wirelessly communicate with the one or more mobile batteries 20. The communications terminal 52 may be an information processing apparatus which has confirmed that at least one of the one or more mobile batteries 20 is legitimate. The communications terminal 52 may be a reliable information processing apparatus for the one or more mobile batteries 20.

Examples of the communications terminal 52 include a personal computer, a portable terminal, and the like. Examples of the portable terminal include a mobile phone, a smartphone, a PDA, a tablet, a notebook computer or a laptop computer, a wearable computer, and the like.

In the present embodiment, the battery station 120 accommodates the mobile battery 20. The battery station 120 may accommodate the plurality of mobile batteries 20. This allows the battery station 120 to preserve the one or more mobile batteries 20. In the present embodiment, the battery station 120 charges at least one of the one or more mobile batteries 20. The battery station 120 may charge the mobile battery 20 until a charging rate or voltage of the mobile battery 20 reaches a predetermined set value.

In the present embodiment, the battery station 120 puts the mobile battery 20 which is fully charged into a state where the mobile battery can be taken out (may be referred to as dispensed) therefrom. The battery station 120 may dispense, in response to a request from the user 40, the mobile battery 20 meeting that request. The battery station 120 may obtain, from the management server 140, information indicating a dispensation condition which is a condition relating to the mobile battery 20 to be dispensed, and decide the mobile battery 20 to be actually dispensed from among the mobile batteries 20 meeting that dispensation condition.

Note that, in another embodiment, the battery station 120 may discharge at least some of the plurality of mobile batteries 20. The battery station 120 may use electric power outputted by discharging the mobile batteries 20. For example, the battery station 120 operates by consuming the electric power outputted by discharging the mobile batteries 20. When operating by consuming electric power outputted by discharging one mobile battery 20, the battery station 120 may stop or suspend an operation of charging the other mobile batteries 20. Even in this case, the battery station 120 may continue an operation of dispensing the mobile battery 20.

This allows the battery station 120 to use some of the mobile batteries 20 accommodated in the battery station 120 as the uninterruptible power system. According to the battery station 120 according to the present embodiment, for example, even if an abnormality has occurred in electric power supply from the electric power system 12 to the battery station 120, electric power supply to a control apparatus may be continued. As a result, for example, the dispensation of the mobile battery 20 by the battery station 120 may be continued. Therefore, even if the battery station 120 is placed in, for example, an area where electric power outage occurs relatively frequently, it is possible to provide an environment in which the battery can be stably replaced.

In the present embodiment, the preservation unit 122 retains a plurality of slots 124. In the present embodiment, the preservation unit 122 is formed separately and independently from the communication unit 126. The preservation unit 122 may be placed apart from the communication unit 126 or may be placed so as to abut against the communication unit 126.

In addition, in the present embodiment, the preservation unit 122 generates a processing flow including one or more processes for controlling an operation of at least one of the plurality of slots 124, based on a first instruction transmitted from the communication unit 126. The preservation unit 122 determines, for each of the one or more processes, whether each of the processes can be executed. The preservation unit 122 generates, for the process determined to be executable, a second instruction for controlling the slot 124 targeted by that process. The preservation unit 122 controls the operation of the above-described slot 124 based on the generated second instruction. This may restrict execution of some of directions indicated by the first instruction.

For example, if the above-described one or more processes include an operation involved in safety of the mobile battery 20 or safety of the user 40 or maintenance personnel of the battery station 120, the preservation unit 122 determines whether a condition is satisfied under which execution of the operation involved in that safety is permitted. If it is determined that the above-described condition is satisfied, the preservation unit 122 determines that process to be executable. This controls the operation of the slot 124 based on the second instruction relating to the above-described process. On the other hand, if it is determined that the above-described condition is not satisfied, the preservation unit 122 determines that process to be non-executable. In this case, the second instruction relating to the above-described process is not transmitted to the slot 124.

This may ensure the safety of the mobile battery 20, the user 40, or the above-described maintenance personnel even if the communication unit 126 has outputted the first instruction based on a request from the management server 140. For example, even if a state of the battery station 120 changes after the management server 140 has transmitted the above-described request, when a communication environment of the battery station 120 is good, the management server 140 can cancel the above-described request. However, if the communication environment of the battery station 120 is not good, it may take some time for the management server 140 to cancel the above-described request. According to the present embodiment, since the preservation unit 122 judges, according to the state of the battery station 120, whether the second instruction can be executed, the battery station 120 can discontinue or suspend execution of some processing without waiting for a cancellation request from the management server 140.

In the present embodiment, each of the plurality of slots 124 is configured to be able to preserve at least one of the one or more mobile batteries 20. At least one of the one or more mobile batteries 20 is attached to each of the plurality of slots 124. In addition, each of the plurality of slots 124 includes electrical terminals (not shown) to be electrically connected to electrical terminals (not shown) of the one or more mobile batteries 20. This allows each of the plurality of slots 124 to charge or discharge the mobile battery 20 preserved in each of the slots.

Note that the phrase “electrically connected” is not limited to a case where two elements are physically directly connected to each other. A third element may intervene between the above-described two elements. In addition, the phrase is not limited to a case where the above-described two elements are physically connected to each other. For example, an input winding wire and an output winding wire in a converter are not physically connected, but are electrically connected to each other. This allows the slot 124 to support not only wired charge and discharge of the mobile battery 20 but also wireless charge and discharge of the mobile battery 20.

Each of the plurality of slots 124 may include communication terminals to be communicably connected to communication terminals of the one or more mobile batteries 20. A system for communicating between a communication terminal of the slot 124 and a communication terminal of the mobile battery 20 may be a wired communication system or may be a wireless communication system. This allows each of the plurality of slots 124 to read information from the storage apparatus (not shown) of the mobile battery 20 preserved in each of the slots or write information into that storage apparatus.

In the present embodiment, the communication unit 126 is responsible for information processing involving at least one of the user 40 or the management server 140, in information processing in the battery station 120. For example, the communication unit 126 receives a request which is from at least one of the user 40 or the management server 140 and responds to that request. The communication unit 126 transmits an instruction (may be referred to as a command) to the preservation unit 122 if it judges that the preservation unit 122 is required in order to process the request from at least one of the user 40 or the management server 140. The above-described first instruction may be an example of the instruction.

If the communication unit 126 can process the request from at least one of the user 40 or the management server 140 without cooperating with the preservation unit 122, the communication unit 126 may not transmit the instruction to the preservation unit 122. This simplifies information processing in the preservation unit 122. The communication unit 126 can execute, for example, control processing on communication with an outside of the battery station 120, authentication processing on the user 40, selection processing on the slot 124, or the like, without cooperating with the preservation unit 122.

As described above, in the present embodiment, the communication unit 126 is formed separately and independently from the preservation unit 122. The preservation unit 122 may be placed apart from the communication unit 126 or may be placed so as to abut against the communication unit 126.

The communication interface 128 is configured to be able to communicate with the information processing apparatus external to the battery station 120. The communication interface 128 may support a plurality of communication systems. The communication interface 128 may support the wired communication system or may support the wireless communication system. In one embodiment, the communication interface 128 transmits and receives information to and from the communications terminal 42 used by the user 40. In another embodiment, the communication interface 128 transmits and receives information to and from the management server 140.

In the present embodiment, the management server 140 is arranged outside the battery station 120. In addition, the management server 140 can transmit and receive information to and from the communication unit 126 of the battery station 120 via the communication network 14.

In the present embodiment, the management server 140 manages the one or more mobile batteries 20. For example, the management server 140 manages respective states of the one or more mobile batteries 20. The management server 140 may manage return and dispensation of each of the one or more mobile batteries 20. The management server 140 may transmit a variety of requests for managing the mobile battery 20 to at least one of the one or more battery stations 120.

The management server 140 may manage the one or more battery stations 120. The management server 140 may manage the respective states of the one or more battery stations 120. Examples of the states of the battery station 120 include a supplying state of external electric power, the number of the mobile batteries 20 which can be received, the number of the mobile batteries 20 which can be dispensed, the presence or absence, the number, or identification information of the mobile batteries 20 which can be used as the uninterruptible power system, charging states of the above-described mobile batteries 20, and the like. The management server 140 may transmit a variety of requests for managing the battery station 120 to at least one of the one or more battery stations 120.

The management server 140 may decide, for at least some of the one or more battery stations 120, the dispensation condition which is the condition relating to the mobile battery 20 to be dispensed. Examples of the dispensation condition include a priority relating to the dispensation of each of the plurality of mobile batteries 20 accommodated in the battery station 120, identification information of the mobile battery 20 to be preferentially dispensed, a feature of the mobile battery 20 to be preferentially dispensed, and the like.

In the present embodiment, the management server 140 may be used for distribution processing on the variety of keys such as the authentication public key 74. The management server 140 may have a database which associates and stores the battery ID and the above-described variety of keys for each of the one or more mobile batteries 20. The above-described database may associate and store the respective battery IDs of the one or more mobile batteries 20 and the respective authentication public keys 74 of the one or more mobile batteries 20. In response to a request from each of the one or more battery stations 120, the management server 140 may extract the authentication public key 74 of the mobile battery 20 indicated by that request and transmit the extracted authentication public key 74.

The management server 140 may be configured to be able to wirelessly communicate with the one or more battery stations 120. The management server 140 may be an information processing apparatus which has confirmed that at least one of the one or more battery stations 120 is legitimate. The management server 140 may be a reliable information processing apparatus for the one or more battery stations 120. The management server 140 may be configured to be able to wirelessly communicate with the one or more mobile batteries 20. The management server 140 may be an information processing apparatus which has confirmed that at least one of the one or more mobile batteries 20 is legitimate. The management server 140 may be a reliable information processing apparatus for the one or more mobile batteries 20.

The mobile battery 20 may be an example of a to-be-confirmed apparatus, a second electric power apparatus, or an electricity accumulation apparatus. The key issuer 50 may be an example of a manufacturer or a transferor of a confirmation apparatus, a manufacturer or a transferor of the to-be-confirmed apparatus, or an issuer of second information and fourth information. The communications terminal 52 may be an example of a first external apparatus or a second external apparatus. The battery management system 100 may be an example of the confirmation apparatus or a confirmation system. The battery station 120 may be an example of the confirmation apparatus, a first electric power apparatus, or a preservation apparatus. The preservation unit 122 may be an example of the first electric power apparatus or the preservation apparatus. The slot 124 may be an example of the first electric power apparatus, the preservation apparatus, or the attachment part. The management server 140 may be an example of the first external apparatus or the second external apparatus.

The authentication code may be an example of first information. The authentication public key 74 may be an example of second information. The authentication code encrypted with the authentication public key 74 may be an example of third information. The challenge code may be an example of the third information. The authentication private key 72 may be an example of the fourth information. The decrypted authentication code may be an example of fifth information. The first processing value of the decrypted authentication code may be an example of sixth information. The first processing value of the authentication code generated by the battery station 120 may be an example of seventh information. The second processing value of the restored authentication code may be an example of eighth information. Information used for the encryption processing of the first algorithm may be an example of ninth information. Information used for the decryption processing of the second algorithm may be an example of the ninth information or tenth information.

Encryption may be an example of conversion of information. Decryption may be an example of inverse conversion of information. The legitimate mobile battery 20 may be an example of a legitimate apparatus. The whitelist may be an example of joint use identification information. A method for authenticating the mobile battery 20 may be an example of a method for confirming the mobile battery 20.

(Example of Another Embodiment)

In the present embodiment, the battery management system 100 has been described in detail by taking as an example a case where the battery management system 100 provides the sharing service of the mobile battery 20. However, the service provided by the battery management system 100 is not limited to the present embodiment. In another embodiment, the battery management system 100 may provide the charging service of the mobile battery 20 to the user 40 of the mobile battery 20.

In the present embodiment, the battery station 120 has been described in detail by taking as an example a case where the battery station 120 works by using the electric power received from the electric power system 12. However, the battery station 120 is not limited to the present embodiment. In another embodiment, for example, if at least one of the one or more slots 124 arranged in the battery station 120 includes a bi-directional DC/DC converter, the battery station 120 may work by using the electric power discharged by at least one of the one or more mobile batteries 20 preserved in the battery station 120.

In the present embodiment, the battery management system 100 has been described in detail by taking as an example a case where the battery station 120 includes the one or more preservation units 122 and a single communication unit 126. However, the battery station 120 is not limited to the present embodiment. In another embodiment, the battery station 120 may include a plurality of preservation units 122 and a plurality of communication units 126. In this case, the number of the preservation units 122 may be larger than the number of the communication units 126.

In the present embodiment, the battery management system 100 has been described in detail by taking as an example a case where each of the one or more battery stations 120 obtains the authentication public keys 74 of the one or more mobile batteries 20 from the key issuer 50, the communications terminal 52, or the management server 140. However, a method for obtaining the authentication public key 74 in the battery station 120 is not limited to the present embodiment. In another embodiment, each of the one or more battery stations 120 may obtain, from the mobile battery 20 attached to the slot 124, the authentication public key 74 of that mobile battery.

In the present embodiment, an example of the method for authenticating the mobile battery 20 has been described by taking as an example a case where (i) the battery station 120 generates the authentication code, (ii) the battery station 120 encrypts the generated authentication code with the authentication public key 74, to generate the challenge code, and (iii) the mobile battery 20 decrypts the encrypted authentication code included in the challenge code with the authentication private key 72, to generate the response code. However, the method for authenticating the mobile battery 20 is not limited to the present embodiment. According to another embodiment, the electronic signature is used to authenticate the mobile battery 20.

For example, (i) the mobile battery 20 generates the authentication code, (ii) the mobile battery 20 signs the generated authentication code (or the generated authentication code and the battery ID) by using the private key, and (iii) the mobile battery 20 transmits the generated authentication code (plaintext), the battery ID (plaintext), data (ciphertext) signed with the private key to the battery station 120. Subsequently, (iv) the battery station 120 obtains the public key associated with the battery ID of the mobile battery 20, and (v) the battery station 120 verifies the signature by using that public key. According to the present embodiment, when validity of the signature is confirmed, authenticity of the mobile battery 20 may also be confirmed.

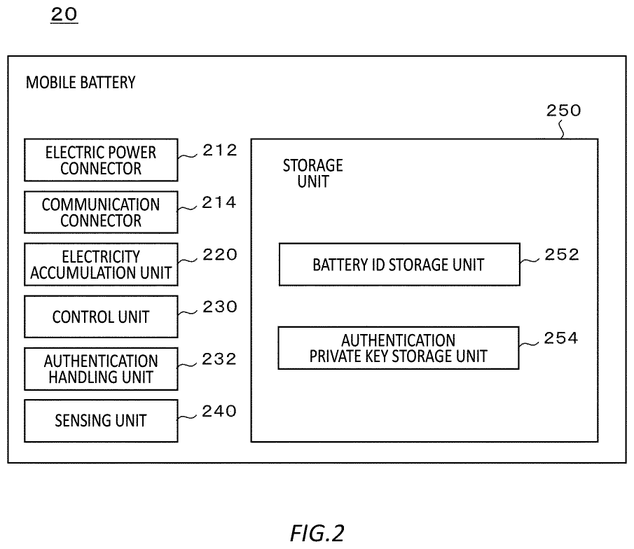

FIG. 2 schematically shows an example of an internal configuration of the mobile battery 20. In the present embodiment, the mobile battery 20 includes an electric power connector 212, a communication connector 214, an electricity accumulation unit 220, a control unit 230, an authentication handling unit 232, a sensing unit 240, and a storage unit 250. In the present embodiment, the storage unit 250 has a battery ID storage unit 252 and an authentication private key storage unit 254.

In the present embodiment, the electric power connector 212 includes an electrical terminal for transmitting and receiving electric power to and from the slot 124 or the electric motorcycle 30. In the present embodiment, the communication connector 214 includes a communication terminal for transmitting and receiving information to and from the slot 124 or the electric motorcycle 30. In the present embodiment, the electricity accumulation unit 220 includes an electricity accumulation cell which accumulates electrical energy.

In the present embodiment, the control unit 230 controls an operation of the mobile battery 20. The control unit 230 may transmit and receive information to and from the preservation unit 122 when the mobile battery 20 is preserved in the slot 124.

In the present embodiment, the authentication handling unit 232 handles an authentication response request from the battery station 120. For example, if the mobile battery 20 is attached to one of the slots 124 of the battery station 120, the authentication handling unit 232 receives a challenge code and the authentication response request from the battery station 120. The authentication handling unit 232 transmits a response code to the battery station 120 in response to the authentication response request. The authentication handling unit 232 will be described later in detail.

In the present embodiment, the sensing unit 240 obtains information indicating a state of the mobile battery 20. The sensing unit 240 may include a plurality of types of sensors. Examples of the sensors included in the sensing unit 240 include a temperature sensor, a voltage sensor, a current sensor, and the like.

The storage unit 250 stores a variety of information relating to the mobile battery 20. For example, the storage unit 250 stores identification information of the mobile battery 20. The storage unit 250 may store identification information of the electric motorcycle 30, the battery station 120, or the slot 124 electrically connected to the mobile battery 20. The storage unit 250 may store an operation history of the mobile battery 20. For example, the storage unit 250 associates time and a result of measurement by the sensing unit 240 and stores them as the operation history of the mobile battery 20.

In the present embodiment, the battery ID storage unit 252 stores a battery ID of the mobile battery 20. In the present embodiment, the authentication private key storage unit 254 stores the authentication private key 72 of the mobile battery 20.

The electric power connector 212 may be an example of the electrical terminal or a second terminal. The electricity accumulation unit 220 may be an example of an electricity accumulation apparatus. The authentication private key storage unit 254 may be an example of a storage unit. The authentication handling unit 232 may be an example of a third information obtainment unit, a fifth information generation unit, or a response unit.

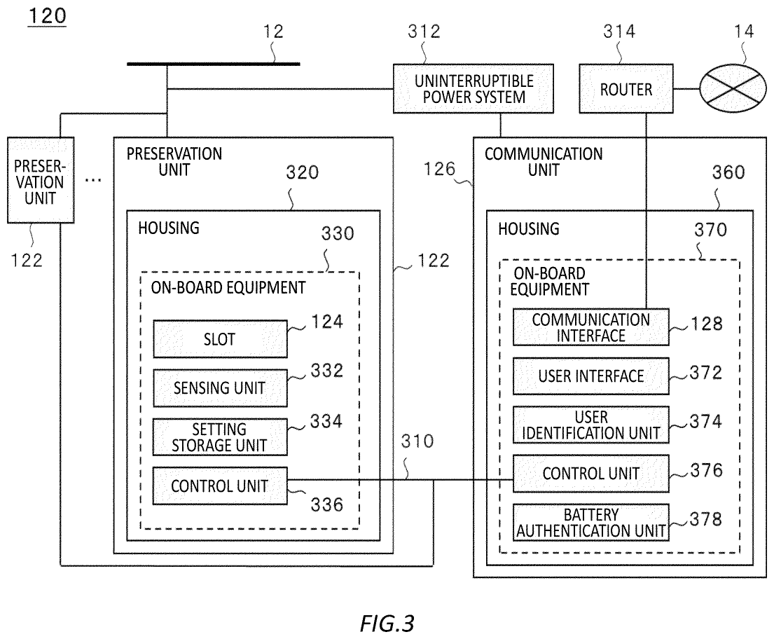

FIG. 3 schematically shows an example of an internal configuration of the battery station 120. In the present embodiment, the battery station 120 includes the one or more preservation units 122, the communication unit 126, a communication line 310, an uninterruptible power system 312, and a router 314. In the present embodiment, each of the one or more preservation units 122 has a housing 320 and on-board equipment 330. In the present embodiment, the on-board equipment 330 includes the one or more slots 124, a sensing unit 332, a setting storage unit 334, and a control unit 336. In the present embodiment, the communication unit 126 has a housing 360 and on-board equipment 370. In the present embodiment, the on-board equipment 370 includes the communication interface 128, a user interface 372, a user identification unit 374, a control unit 376, and a battery authentication unit 378.

In the present embodiment, each of the one or more slots 124 is configured to be freely attached to and detached from the mobile battery 20. In addition, each of the one or more slots 124 supplies electric power to the mobile battery 20 to charge the electricity accumulation unit 220 of the mobile battery 20. Each of the one or more slots 124 may receive the electric power outputted by the mobile battery 20.

In the present embodiment, the communication line 310 connects each of the one or more preservation units 122 and the communication unit 126 together. In the present embodiment, the uninterruptible power system 312 is arranged between the electric power system 12 and the communication unit 126. The uninterruptible power system 312 supplies electric power to the communication unit 126, for example, if an abnormality has occurred in electric power supply from the electric power system 12. In the present embodiment, the router 314 relays or transfers communication between the communication unit 126 and the communication network 14.

In the present embodiment, the housing 320 retains the on-board equipment 330. A shape and a material of the housing 320 are not particularly limited. The housing 320 may have a box shape, may have a board shape, or may have a frame shape.

In the present embodiment, the on-board equipment 330 is mounted on the housing 320. A manner in which the on-board equipment 330 is mounted is not particularly limited. The on-board equipment 330 may be accommodated inside the housing 320 or may be installed on a surface of the housing 320.

In the present embodiment, the sensing unit 332 obtains information indicating a state of the slot 124 or the mobile battery 20 to be preserved in the slot 124. The sensing unit 332 may include a plurality of types of sensors. Examples of the sensors included in the sensing unit 240 include a temperature sensor, a voltage sensor, a current sensor, and the like.

In the present embodiment, the setting storage unit 334 stores a variety of settings relating to the preservation unit 122. The setting storage unit 334 may have a physical switch or may have any type of storage medium such as a memory or a hard disk. The above-described settings (i) may be indicated by ON/OFF of the physical switch or (ii) may be stored in a storage medium as electronic data. Examples of the above-described settings include a setting relating to an ID of the preservation unit 122, a setting relating to a position at which the preservation unit 122 is placed, a setting relating to whether a variety of operations in the preservation unit 122 can be executed, and the like.

In the present embodiment, the control unit 336 controls an operation of the preservation unit 122. Examples of the above-described operation include attachment or detachment of the mobile battery 20 to or from the slot 124, charge or discharge of the mobile battery 20, and the like.

In one embodiment, the control unit 336 controls the attachment or the detachment of the mobile battery 20 to or from the slot 124. Examples of the above-described control include lock control over a shutter (not shown) arranged in the slot 124, control over a withdrawal prevention member (not shown) arranged in the slot 124, control over a mechanism (not shown) for confining the mobile battery 20 arranged in the slot 124, control over a movable connector (not shown) arranged in the slot 124, and the like. The movable connector may be a mechanical connector or may be an electric connector.

In another embodiment, the control unit 336 controls the charge or discharge of the mobile battery 20 preserved in the slot 124. Examples of the above-described control include confirmation of connection of electrical terminals, adjustment of charging voltage, adjustment of charging current, adjustment of discharging voltage, adjustment of discharging current, and the like. This allows control over the charge or discharge of the mobile battery 20 via the electrical terminals.

The control unit 336 may control the operation of the preservation unit 122 based on an instruction received from the control unit 376. The control unit 336 generates a processing flow including one or more processes for controlling an operation of at least one of the plurality of slots 124 based on the instruction received from the control unit 376, for example. The control unit 336 determines, for each of the one or more processes, whether each of the processes can be executed. For the process determined to be executable, the control unit 336 generates an instruction and transmits that instruction to the slot 124 to be controlled. On the other hand, for the process determined to be non-executable, the above-described instruction is not generated or transmitted.

The control unit 336 may transmit, to the control unit 376, information indicating a result of execution of the operation which is based on the instruction received from the control unit 376. For example, the control unit 336 transmits, to the control unit 376, information indicating whether the preservation unit 122 has executed the operation in accordance with the instruction received from the control unit 376.

In the present embodiment, the housing 360 retains the on-board equipment 370. A shape and a material of the housing 360 are not particularly limited. The housing 360 may have a box shape, may have a board shape, or may have a frame shape.

In the present embodiment, the on-board equipment 370 is mounted on the housing 360. A manner in which the on-board equipment 370 is mounted is not particularly limited. The on-board equipment 370 may be accommodated inside the housing 360 or may be installed on a surface of the housing 360.

In the present embodiment, the user interface 372 provides a variety of information to the user 40 who uses the battery station 120. In addition, the user interface 372 accepts an input from the user 40 who uses the battery station 120. Examples of the user interface 372 include a display, a speaker, a keyboard, a pointing device, a touch panel, a microphone, a camera, a voice input system, a gesture input system, and the like.

In the present embodiment, the user identification unit 374 identifies the user 40 who uses the battery station 120. A known technique may be adopted as a technique for identifying the user 40. For example, the user identification unit 374 identifies the user 40, by analyzing an image of the user 40 to execute authentication processing on the user 40. The user identification unit 374 may identify the user 40, by using an ID card possessed by the user 40 to execute the authentication processing on the user 40. The user identification unit 374 may identify the user 40, by using the communications terminal 42 possessed by the user 40 to execute the authentication processing on the user 40.

In the present embodiment, the control unit 376 is responsible for information processing involving at least one of the user 40 or the management server 140, in information processing in the battery station 120. For example, the control unit 376 receives a request which is from at least one of the user 40 or the management server 140 and responds to that request. The control unit 376 transmits an instruction (for example, the above-described first instruction) to the preservation unit 122 if it judges that the preservation unit 122 is required in order to process the request from at least one of the user 40 or the management server 140.

If the control unit 376 can process the request from at least one of the user 40 or the management server 140 without cooperating with the preservation unit 122, the control unit 376 may not transmit the instruction to the preservation unit 122. The control unit 376 can execute, for example, control processing on communication with an outside of the battery station 120, authentication processing on the user 40, selection processing on the slot 124, or the like, without cooperating with the preservation unit 122.

More specifically, when the control unit 376 accepts the request from at least one of the user 40 or the management server 140, the control unit 376 first generates a processing flow including one or more processes for processing that request. Next, the control unit 376 extracts processes including processing in the preservation unit 122, among the above-described one or more processes. The control unit 376 generates, for each of the extracted processes, an instruction indicating a content of the processing in the preservation unit 122.

The above-described instruction may include information indicating the preservation unit 122 (may be referred to as a target unit) to be controlled. The above-described instruction may include information indicating the slot 124 (may be referred to as a target slot) to be controlled. The above-described instruction may include identification information of the target slot and information indicating a content of an operation in the target slot.

Subsequently, the control unit 376 transmits the above-described instruction to the preservation unit 122 to be instructed. The control unit 376 may obtain information indicating a result of execution of the above-described instruction from the preservation unit 122 which has received the above-described instruction.

The battery authentication unit 378 executes authentication processing on the mobile battery 20. For example, the battery authentication unit 378 confirms whether the mobile battery 20 attached to the slot 124 is the legitimate mobile battery 20. The battery authentication unit 378 will be described later in detail.

The battery authentication unit 378 may be an example of a confirmation apparatus. The slot 124 may be an example of a charging apparatus.

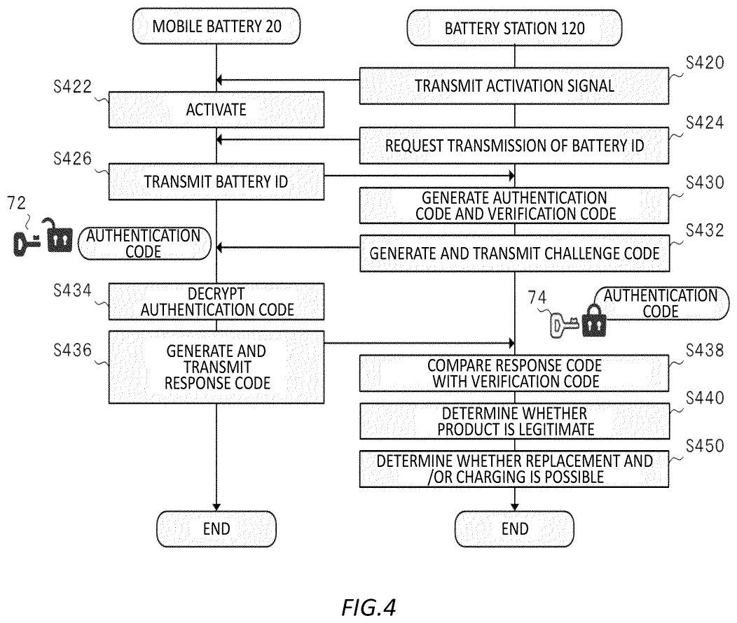

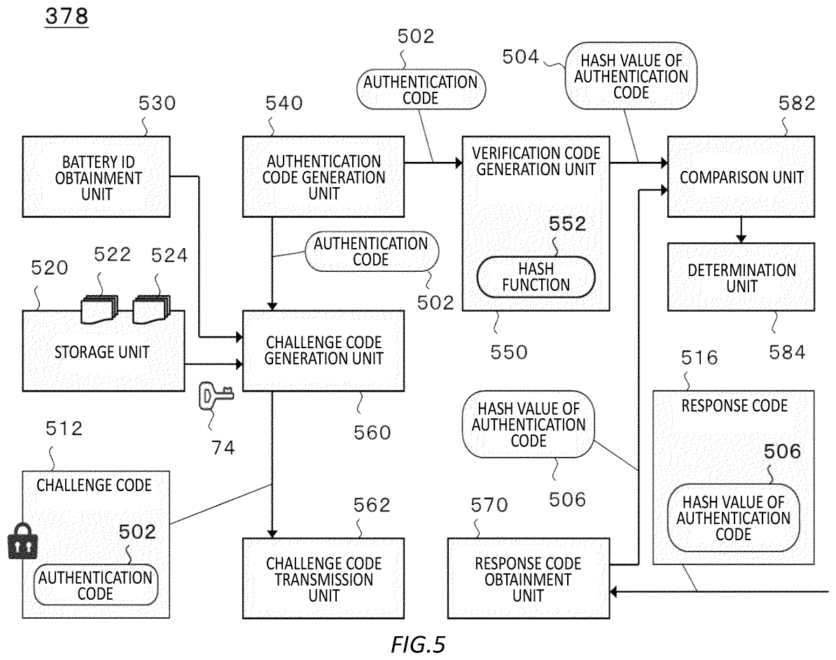

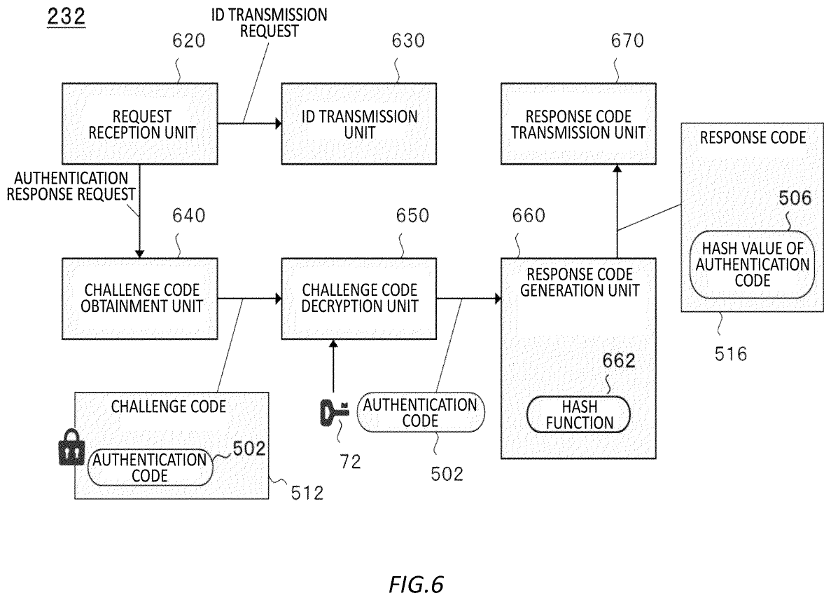

An example of authentication processing on the mobile battery 20 in the battery station 120 will be described in detail by using FIG. 4, FIG. 5, and FIG. 6. FIG. 4 schematically shows an example of a procedure for authenticating the mobile battery 20. FIG. 5 schematically shows an example of an internal configuration of the battery authentication unit 378 for realizing the authentication procedure to be described with reference to FIG. 4. FIG. 6 schematically shows an example of an internal configuration of the authentication handling unit 232 for realizing the authentication procedure to be described with reference to FIG. 4. Note that the authentication processing on the mobile battery 20 in the battery station 120, the authentication handling unit 232, and the battery authentication unit 378 are not limited to the present embodiment.

In the embodiment to be described with reference to FIG. 4, the example of the authentication processing on the mobile battery 20 will be described by taking as an example a case where a step of obtaining, by the mobile battery 20, the authentication private key 72 of the mobile battery 20 from the key issuer 50, the communications terminal 52, or the management server 140 has been already completed. In the above-described obtainment processing, the mobile battery 20 stores the authentication private key 72 in, for example, the authentication private key storage unit 254.

In addition, in the embodiment to be described with reference to FIG. 4, the example of the authentication processing on the mobile battery 20 will be described by taking as an example a case where a step of obtaining, by the battery station 120, database relating to the authentication public keys 74 of the one or more mobile batteries 20 described above from the key issuer 50, the communications terminal 52, or the management server 140 has been already completed. In the above-described obtainment processing, the battery station 120 stores the database relating to the authentication public keys 74 of the one or more mobile batteries 20 in, for example, a storage apparatus arranged in the on-board equipment 370 or the battery authentication unit 378.

In the present embodiment, the authentication private key storage unit 254 stores the authentication private key 72 of the mobile battery 20 at a stage where processing of the authentication processing on the mobile battery 20 is started. Similarly, the battery authentication unit 378 of the battery station 120 includes the database relating to the authentication public keys 74 of the one or more mobile batteries 20.

As shown in FIG. 4, according to the present embodiment, first, in Step 420 (Step may be abbreviated as S), the battery authentication unit 378 of the battery station 120 detects that the mobile battery 20 has been attached to the slot 124. When the battery authentication unit 378 of the battery station 120 detects that the mobile battery 20 has been attached to the slot 124, the battery authentication unit 378 of the battery station 120 transmits an activation signal to the mobile battery 20.

In S 422, when the control unit 230 of the mobile battery 20 receives the activation signal, for example, the control unit 230 and the authentication handling unit 232 are activated. At this time, the control unit 230 may transmit, to the battery station 120, an activation confirmation signal indicating that the authentication handling unit 232 has been activated.

Next, in S 424, the battery authentication unit 378 transmits, to the mobile battery 20, a signal requesting transmission of a battery ID (may be referred to as an ID transmission request). In S 426, for example, when the control unit 230 of the mobile battery 20 receives an ID transmission request signal, the control unit 230 transmits, to the battery station 120, the battery ID stored in the battery ID storage unit 252.

Next, in S 430, when the battery authentication unit 378 obtains the battery ID of the mobile battery 20, the battery authentication unit 378 refers to the database relating to the authentication public key 74 described above by using that battery ID as a key, to extract the authentication public key 74 matching that battery ID. If the authentication public key 74 matching the battery ID is not extracted, the battery authentication unit 378 may access the communications terminal 52 or the management server 140, to obtain the authentication public key 74 matching that battery ID.

In addition, the battery authentication unit 378 prepares an authentication code. For example, the battery authentication unit 378 generates a random number and decides to use that random number as the authentication code.

Next, the battery authentication unit 378 converts the authentication code based on the authentication public key 74 of the mobile battery 20 and generates a challenge code including the converted authentication code. For example, the battery authentication unit 378 encrypts the authentication code by using the authentication public key 74 of the mobile battery 20. In addition, the battery authentication unit 378 generates a challenge code including the encrypted authentication code.

Further, in the present embodiment, the battery authentication unit 378 prepares a verification code. For example, the battery authentication unit 378 executes arithmetic processing using a hash function, to generate a hash value of the authentication code. The battery authentication unit 378 decides to use the generated hash value as the verification code.

Next, in S 432, the battery authentication unit 378 transmits the challenge code to the mobile battery 20. The battery authentication unit 378 may transmit the challenge code and an authentication response request to the battery station 120.

In S 434, when the authentication handling unit 232 receives the challenge code, the authentication handling unit 232 inversely converts the encrypted authentication code included in the challenge code, based on the authentication private key 72 stored in the authentication private key storage unit 254. Specifically, the authentication handling unit 232 decrypts the encrypted authentication code included in the challenge code, by using the authentication private key 72 stored in the authentication private key storage unit 254. Since the authentication private key 72 is paired with the authentication public key 74, if the mobile battery 20 is the legitimate mobile battery 20, the authentication handling unit 232 will successfully decrypt the encrypted authentication code.

Next, in S 436, the authentication handling unit 232 generates a response code including information indicating that the mobile battery 20 has successfully decrypted the authentication code encrypted with the authentication public key 74. For example, the authentication handling unit 232 executes the arithmetic processing using the hash function, to generate a hash value of the decrypted authentication code. The authentication handling unit 232 generates a response code including the hash value of the decrypted authentication code. In addition, the authentication handling unit 232 transmits the response code to the battery station 120.

Next, in S 438, when the battery authentication unit 378 receives the response code, the battery authentication unit 378 compares the hash value included in the response code with the hash value generated as the verification code. In addition, in S 440, it is determined whether the mobile battery 20 is the legitimate mobile battery 20, based on a result of the above-described comparison.

According to the present embodiment, in S 450, the battery authentication unit 378 may determine whether to replace the mobile battery 20, based on a result of the determination in S 440. For example, if the mobile battery 20 is not determined to be the legitimate mobile battery 20, it is decided not to attach the mobile battery 20 to the slot 124.

The battery authentication unit 378 may determine whether to replace the mobile battery 20, based on the result of the determination in S 440 and the whitelist described above. For example, if the mobile battery 20 is determined to be the legitimate mobile battery 20, the battery authentication unit 378 determines whether the mobile battery 20 is a mobile battery 20 which can be used by a plurality of users 40.

Specifically, the battery authentication unit 378 confirms whether the battery ID of the mobile battery 20 described above is listed in the whitelist. If the battery ID of the mobile battery 20 described above is listed in the whitelist, the battery authentication unit 378 determines that the mobile battery 20 is the mobile battery 20 which can be used by the plurality of users 40. On the other hand, if the battery ID of the mobile battery 20 described above is not listed in the whitelist, the battery authentication unit 378 determines that the mobile battery 20 is not the mobile battery 20 which can be used by the plurality of users 40.

If it is determined that the mobile battery 20 is not the mobile battery 20 which can be used by the plurality of users 40, the battery authentication unit 378 may decide not to attach the mobile battery 20 to the slot 124. This suppresses the above-described mobile battery 20 from being preserved in the battery station 120, if the user 40 of the mobile battery 20 has not subscribed to a charging service of the mobile battery 20 or a replacement service of the mobile battery 20 by the battery management system 100, even if the mobile battery 20 is the legitimate mobile battery 20, for example.

If it is decided not to attach the mobile battery 20 to the slot 124, even if the mobile battery 20 is attached to the slot 124 in order to execute the authentication processing on the mobile battery 20, the battery station 120 may release the attachment of the mobile battery 20 and return the mobile battery 20 to the user 40. Note that a manner in which the mobile battery 20 is attached to the slot 124 is not particularly limited. The manner may be a manner in which the mobile battery 20 is accommodated inside the slot 124 or may be a manner in which the mobile battery 20 is placed on the slot 124.

In addition, according to the present embodiment, in S 450, the battery authentication unit 378 may determine whether to charge and/or discharge the mobile battery 20, based on the determination in S 440. For example, if the mobile battery 20 is not determined to be the legitimate mobile battery 20, it is decided not to charge and/or discharge the mobile battery 20 with respect to the slot 124. This allows prohibition or suppression of output and input of electric power between the slot 124 and the mobile battery 20. The battery authentication unit 378 may determine, with a procedure similar to the procedure described above, whether to charge and/or discharge the mobile battery 20, based on the result of the determination in S 440 and the whitelist described above.

Note that processing in the mobile battery 20 may be executed by a single processor or may be executed through cooperation among a plurality of processors. Similarly, processing in the battery station 120 may be executed by the single processor or may be executed through the cooperation among the plurality of processors. This further improves security.

For example, the mobile battery 20 includes a CPU for control for controlling a variety of operations of the mobile battery 20 and a secure IC which executes encryption processing and decryption processing. S 422 and S 426 are executed by the above-described CPU for control. In addition, in S 434, when the CPU for control receives the challenge code, the CPU for control transfers the challenge code to the secure IC. The secure IC decrypts the challenge code in S 434 and generates the response code in S 436. In addition, in S 436, the secure IC outputs the generated response code to the CPU for control. In S 436, the CPU for control transmits the response code generated by the secure IC to the battery station 120.

As shown in FIG. 5, in the present embodiment, the battery authentication unit 378 includes a storage unit 520, a battery ID obtainment unit 530, an authentication code generation unit 540, a verification code generation unit 550, a challenge code generation unit 560, a challenge code transmission unit 562, a response code obtainment unit 570, a comparison unit 582, a determination unit 584. In the present embodiment, the storage unit 520 has a public key database 522 and a whitelist 524.

In the present embodiment, the storage unit 520 stores a variety of information. In the present embodiment, the public key database 522 associates respective battery IDs of the one or more mobile batteries 20 managed by the battery management system 100 and the respective authentication public keys 74 of the one or more mobile batteries 20 described above and stores them. The whitelist 524 stores the battery IDs of the one or more mobile batteries 20 managed by the battery management system 100. Note that, in another embodiment, the public key database 522 may be used as the whitelist 524.

In one embodiment, the battery authentication unit 378 obtains the public key database 522 from the key issuer 50. The battery authentication unit 378 stores, in the storage unit 520, the public key database 522 obtained from the key issuer 50. In another embodiment, the battery authentication unit 378 obtains the public key database 522 from the communications terminal 52 or the management server 140. The battery authentication unit 378 stores, in the storage unit 520, the public key database 522 obtained from the communications terminal 52 or the management server 140.

In the present embodiment, the battery ID obtainment unit 530 obtains the battery ID of the mobile battery 20 to be accommodated in the slot 124 or the battery ID of the mobile battery 20 accommodated in the slot 124. The battery ID obtainment unit 530 may obtain the battery ID of the mobile battery 20 attached to the slot 124. The battery ID obtainment unit 530 may obtain the battery ID of the mobile battery 20 described above from the communications terminal 42 or the mobile battery 20.

In the present embodiment, the authentication code generation unit 540 generates an authentication code 502. The authentication code generation unit 540 may generate the authentication code 502 by generating a random number.

In the present embodiment, the verification code generation unit 550 generates a verification code. The verification code generation unit 550 generates the verification code according to a rule for the mobile battery 20 to generate a response code. If the mobile battery 20 generates the response code including a restored authentication code itself, the verification code generation unit 550 may not generate the verification code and may decide to use the authentication code as the verification code.

In the present embodiment, the verification code generation unit 550 executes arithmetic processing using a hash function 552, to generate a hash value 504 of the authentication code 502. The verification code generation unit 550 decides to use the generated hash value 504 as the verification code. The verification code generation unit 550 outputs the above-described hash value 504 to the comparison unit 582 as the verification code.

In the present embodiment, the challenge code generation unit 560 generates a challenge code 512. For example, the challenge code generation unit 560 encrypts the authentication code 502 by using the authentication public key 74 of the mobile battery 20. This allows the battery authentication unit 378 to generate the challenge code 512 including the encrypted authentication code 502.

In the present embodiment, the challenge code transmission unit 562 transmits, to the battery station 120, the challenge code 512 generated by the challenge code transmission unit 562. The challenge code transmission unit 562 may transmit the challenge code 512 and an authentication response request to the battery station 120.

In the present embodiment, the response code obtainment unit 570 obtains the response code 516 corresponding to the challenge code 512 from the mobile battery 20. In the present embodiment, the response code 516 includes the hash value 506 of the authentication code 502 restored in the mobile battery 20. The response code obtainment unit 570 outputs the hash value 506 of the restored authentication code 502 to the comparison unit 582.

In the present embodiment, the comparison unit 582 obtains the hash value 504 used as the verification code from the verification code generation unit 550. In addition, the comparison unit 582 obtains the hash value 506 included in the response code 516 from the response code obtainment unit 570. The comparison unit 582 compares the hash value 504 used as the verification code with the hash value 506 included in the response code 516. The comparison unit 582 outputs, to the determination unit 584, information indicating a result of the comparison.

In the present embodiment, the determination unit 584 obtains information indicating a result of the comparison by the comparison unit 582. The determination unit 584 determines whether the mobile battery 20 is the legitimate mobile battery 20, based on the result of the comparison by the comparison unit 582.

The determination unit 584 may determine whether to replace the mobile battery 20, based on a result of the determination as to whether the mobile battery 20 is the legitimate mobile battery 20. The determination unit 584 may determine whether to replace the mobile battery 20, based on the result of the determination as to whether the mobile battery 20 is the legitimate mobile battery 20 and on the whitelist 524.

The determination unit 584 may determine whether to charge and/or discharge the mobile battery 20, based on the result of the determination as to whether the mobile battery 20 is the legitimate mobile battery 20. This allows prohibition or suppression of output and input of electric power between the slot 124 and the mobile battery 20. The determination unit 584 may determine whether to charge and/or discharge the mobile battery 20, based on the result of the determination as to whether the mobile battery 20 is the legitimate mobile battery 20 and on the whitelist 524.

The storage unit 520 may be an example of a first storage apparatus. The challenge code generation unit 560 may be an example of a third information generation unit. The challenge code transmission unit 562 may be an example of a third information transmission unit. The response code obtainment unit 570 may be an example of a response reception unit. The comparison unit 582 may be an example of a comparison unit.

As shown in FIG. 6, in the present embodiment, the authentication handling unit 232 includes a request reception unit 620, an ID transmission unit 630, a challenge code obtainment unit 640, a challenge code decryption unit 650, a response code generation unit 660, and a response code transmission unit 670.

In the present embodiment, the request reception unit 620 receives a variety of requests from the battery station 120. Examples of the above-described requests include an ID transmission request, an authentication response request, and the like. In the present embodiment, if the request reception unit 620 receives the ID transmission request from the battery station 120, the ID transmission unit 630 transmits a battery ID of the mobile battery 20 to the battery station 120.

In the present embodiment, if the request reception unit 620 receives the authentication response request from the battery station 120, the challenge code obtainment unit 640 obtains the challenge code 512 transmitted by the battery station 120. In the present embodiment, the challenge code decryption unit 650 uses the authentication private key 72 to decrypt the encrypted authentication code 502 included in the challenge code 512, to generate the authentication code 502. In addition, the challenge code decryption unit 650 outputs the decrypted authentication code 502 to the response code generation unit 660.

In the present embodiment, the response code generation unit 660 generates the response code 516 based on the decrypted authentication code 502. The response code generation unit 660 may generate the response code 516 in any format in accordance with the rule described above.

According to the present embodiment, the response code generation unit 660 executes arithmetic processing using a hash function 662, to generate the hash value 506 of the restored authentication code 502. The response code generation unit 660 generates the response code 516 including the hash value 506 of the restored authentication code 502. In the present embodiment, the response code transmission unit 670 transmits the response code 516 to the battery station 120.

The challenge code obtainment unit 640 may be an example of a third information obtainment unit. The challenge code decryption unit 650 may be an example of a fifth information generation unit. The response code transmission unit 670 may be an example of a response unit.

(Example of Another Embodiment)

In the present embodiment, an example of information processing in the battery station 120 has been described by taking as an example a case where, if it is determined in S 450 of FIG. 4 that the mobile battery 20 attached to the slot 124 is not the mobile battery 20 which can be used by the plurality of users 40, the battery authentication unit 378 decides not to attach the mobile battery 20 to the slot 124 or not to charge or discharge the mobile battery 20. However, the information processing for a case where it is determined that the mobile battery 20 attached to the slot 124 is not the mobile battery 20 which can be used by the plurality of users 40 is not limited to the present embodiment. In another embodiment, if it is determined that the mobile battery 20 attached to the slot 124 is not the mobile battery 20 which can be used by the plurality of users 40, the battery authentication unit 378 may execute processing of attaching the mobile battery 20 to the slot 124 in accordance with a predetermined first rule or may execute charging processing or discharging processing on the mobile battery 20 in accordance with a predetermined second rule.

Examples of the first rule include a rule which allows the mobile battery 20 to be attached to the slot 124 but does not allow the users 40 other than the user 40 who has attached the above-described mobile battery 20 to the slot 124 to take out the above-described mobile battery 20. Examples of the second rule include a rule which allows the mobile battery 20 to be charged or discharged until the number of times that the mobile battery 20 has been attached to the slot 124 reaches a predetermined number of times or frequency but does not allow the mobile battery 20 to be charged or discharged if the number of times that the mobile battery 20 has been attached to the slot 124 exceeds the above-described number of times or frequency.

In the present embodiment, an example of authentication processing on the mobile battery 20 has been described by taking as an example a case where the battery station 120 obtains the authentication public key 74 of the mobile battery 20 from the key issuer 50, the communications terminal 52, or the management server 140. However, a method for obtaining the authentication public key 74 in the battery station 120 is not limited to the present embodiment. In another embodiment, the battery station 120 may obtain the authentication public key 74 from the mobile battery 20.

In the present embodiment, the example of the authentication processing on the mobile battery 20 has been described by taking as an example a case where processing of comparing an authentication code and a response code is executed through comparison between a verification code generated from the authentication code and the response code. However, the processing of comparing the authentication code and the response code is not limited to the present embodiment. The authentication code and the response code may be compared by a variety of methods described with reference to FIG. 1.

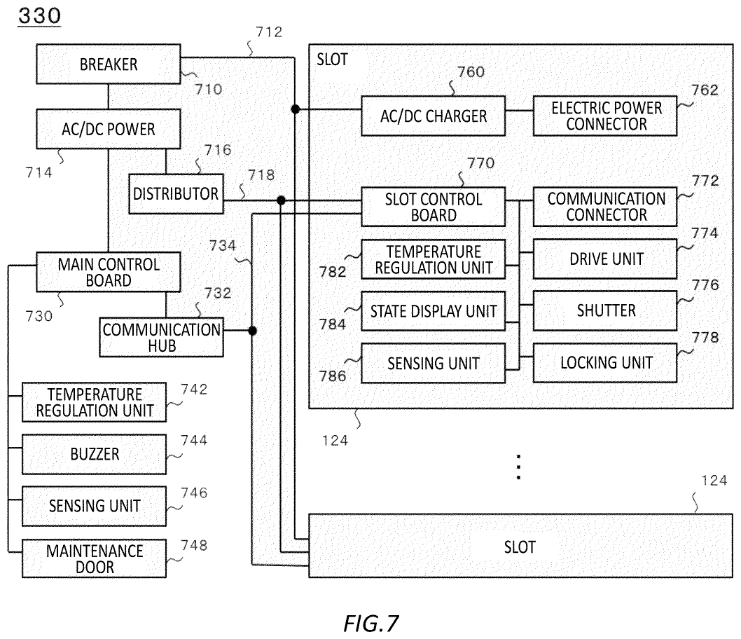

FIG. 7 schematically shows an example of an internal configuration of the on-board equipment 330. In the present embodiment, for ease of explanation, the on-board equipment 330 will be described in detail by taking as an example a case where the slot 124 does not have a function to discharge the mobile battery 20. However, persons skilled in the art who read the description of the present specification could understand that it is possible to change the configuration to a configuration which allows the slot 124 to charge and discharge the mobile battery 20.

In the present embodiment, the on-board equipment 330 includes the one or more slots 124, a breaker 710, an electric power line 712, an AC/DC power 714, a distributor 716, an electric power line 718, a main control board 730, a communication hub 732, a communication line 734, a temperature regulation unit 742, a buzzer 744, a sensing unit 746, and a maintenance door 748. In the present embodiment, the slot 124 has an AC/DC charger 760, an electric power connector 762, a slot control board 770, a communication connector 772, a drive unit 774, a shutter 776, a locking unit 778, a temperature regulation unit 782, a state display unit 784, and a sensing unit 786.

In the present embodiment, the breaker 710 receives electric power from the electric power system 12. The breaker 710 supplies the electric power received from the electric power system 12, via the electric power line 712 to respective AC/DC chargers 760 of the one ore more slots 124. The breaker 710 supplies the electric power received from the electric power system 12 to the AC/DC power 714. Examples of the breaker 710 include a circuit breaker, a residual current circuit breaker with overcurrent protection, and the like.

In the present embodiment, the AC/DC power 714 functions as a power source which supplies electric power for control. For example, the AC/DC power 714 converts alternating current power received from the breaker 710 into direct current power with appropriate voltage. The AC/DC power 714 supplies the converted direct current power via the distributor 716 and the electric power line 718 to respective slot control boards 770 of the one or more slots 124. In addition, the AC/DC power 714 supplies the converted direct current power to the main control board 730.

In the present embodiment, the main control board 730 controls an operation of each unit of the preservation unit 122. The main control board 730 is connected to a CPU board 820 via the communication line 310. The main control board 730 may function as the control unit 336. The main control board 730 may function as the control unit 336 in cooperation with the slot control board 770.

The main control board 730 transmits and receives information to and from the respective slot control boards 770 of the one or more slots 124 via the communication hub 732 and the communication line 734. The main control board 730 may control operations of the temperature regulation unit 742, the buzzer 744, the sensing unit 746, and the maintenance door 748. The main control board 730 may obtain information indicating states of the temperature regulation unit 742, the buzzer 744, the sensing unit 746, and the maintenance door 748.

For example, the main control board 730 obtains information indicating a result of measurement by the sensing unit 746 from the sensing unit 746. In addition, the main control board 730 obtains information indicating an opened/closed state of the maintenance door 748 from the maintenance door 748.

In the present embodiment, the temperature regulation unit 742 regulates temperature inside the housing 320 of the preservation unit 122. Examples of the temperature regulation unit 742 include a fan, a water cooled heat extractor, and the like.

In the present embodiment, the buzzer 744 informs the user 40 of a state of the preservation unit 122. The buzzer 744 may output a warning sound. The buzzer 744 may output a warning designated by the main control board 730, among a plurality of warning sounds having different warning patterns.

In the present embodiment, the sensing unit 746 obtains information indicating the state of the preservation unit 122. The sensing unit 746 may include a plurality of types of sensors. Examples of the sensors included in the sensing unit 746 include a temperature sensor, a vibration sensor, an electric leakage sensor, and the like. The sensing unit 746 may constitute at least part of the sensing unit 332.

In the present embodiment, the maintenance door 748 is arranged in an opening (not shown) of the housing 320 and is used for maintenance and management of the battery station 120 by maintenance personnel of the battery station 120. The maintenance door 748 may output, to the main control board 730, information indicating an opened/closed state. For example, when the maintenance door 748 is opened, the maintenance door 748 outputs a signal indicating that the maintenance door 748 is opened.

In the present embodiment, the AC/DC charger 760 charges the mobile battery 20 electrically connected to the electric power connector 762. The AC/DC charger 760 adjusts at least one of voltage or current to be applied to the mobile battery 20 electrically connected to the electric power connector 762, in accordance with a direction of the slot control board 770.

In the present embodiment, the electric power connector 762 includes an electrical terminal to be electrically connected to the electric power connector 212 of the mobile battery 20 if the mobile battery 20 is accommodated in the slot 124. In the present embodiment, the electric power connector 762 is configured to be enabled to move by the drive unit 774. Note that, in another embodiment, the electric power connector 762 may be fixed inside the slot 124.

In the present embodiment, the slot control board 770 controls an operation of each unit of the slot 124. The slot control board 770 may control the operation of the slot 124 in accordance with a direction from the main control board 730. The slot control board 770 may function as the control unit 336. The slot control board 770 may function as the control unit 336 in cooperation with the main control board 730.

The slot control board 770 may transmit and receive information to and from the control unit 230 of the mobile battery 20 preserved in the slot 124, via the communication connector 772. For example, the slot control board 770 can read information stored in the storage unit 250 of the mobile battery 20. In addition, the slot control board 770 can write information into the storage unit 250 of the mobile battery 20.

In the present embodiment, the communication connector 772 includes a communication terminal to be communicably connected to the communication connector 214 of the mobile battery 20 if the mobile battery 20 is accommodated in the slot 124. In the present embodiment, the communication connector 772 is configured to be enabled to move by the drive unit 774. Note that, in another embodiment, the communication connector 772 may be fixed inside the slot 124.

In the present embodiment, the drive unit 774 drives a variety of movable members arranged in the slot 124. The drive unit 774 may drive the above-described movable members in accordance with a direction from the slot control board 770. Examples of the movable members include the electric power connector 762, the communication connector 772, the shutter 776, the locking unit 778, a withdrawal prevention member arranged in the slot 124, a mechanism for confining the mobile battery 20 arranged in the slot 124, and the like.

In the present embodiment, the shutter 776 is arranged in an opening (not shown) of the slot 124 and controls whether the user 40 can use the mobile battery 20. The shutter 776 may control opening and closing in accordance with the direction from the slot control board 770.

For example, if the shutter 776 is in an opened state, the user 40 can insert the mobile battery 20 into the slot 124 or take out the mobile battery 20 from the slot 124. On the other hand, if the shutter 776 is in a closed state, the user 40 cannot insert the mobile battery 20 into the slot 124 or take out the mobile battery 20 from the slot 124.

In the present embodiment, the locking unit 778 switches between a locked state and an unlocked state of the shutter 776. The locking unit 778 may switch between the locked state and the unlocked state of the shutter 776 in accordance with the direction from the slot control board 770.

In the present embodiment, the temperature regulation unit 782 regulates temperature inside the slot 124. In the present embodiment, the temperature regulation unit 782 may regulate the temperature inside the slot 124 in accordance with the direction from the slot control board 770. Examples of the temperature regulation unit 782 include the fan, the water cooled heat extractor, and the like.

In the present embodiment, the state display unit 784 informs the user 40 of a state of the slot 124. Examples of the state of the slot 124 include the presence or absence of the mobile battery 20, the presence or absence of an abnormality, and the like. The state display unit 784 may inform the user 40 of the state of the slot 124 with, for example, a lighting pattern, a flashing pattern, or a display pattern designated by the slot control board 770, among a plurality of lighting patterns, flashing patterns, or display patterns. Examples of the state display unit 784 include an LED, a display, and the like.

In the present embodiment, the sensing unit 786 obtains information indicating the state of the slot 124. The sensing unit 786 may include a plurality of types of sensors. Examples of the sensors included in the sensing unit 786 include a temperature sensor, a voltage sensor, a current sensor, and the like. For example, the sensing unit 786 includes at least one of (i) a temperature sensor which measures the temperature inside the slot 124, temperature of the mobile battery 20, or temperature near the mobile battery 20, (ii) a voltage sensor which measures voltage of the electric power connector 762, or (iii) a current sensor which measures current flowing through the electric power connector 762. The sensing unit 786 may constitute at least part of the sensing unit 332.

The main control board 730 may be an example of a confirmation apparatus. The electric power connector 762 may be an example of a first terminal. The slot control board 770 may be an example of a confirmation apparatus.

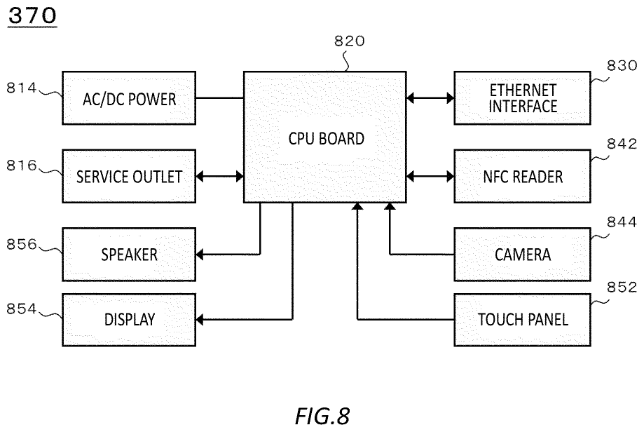

FIG. 8 schematically shows an example of an internal configuration of the on-board equipment 370. In the present embodiment, the on-board equipment 370 includes an AC/DC power 814, a service outlet 816, a CPU board 820, an Ethernet interface 830 which is a communication interface of an Ethernet (registered trademark), an NFC reader 842, a camera 844, a touch panel 852, a display 854, and a speaker 856.

In the present embodiment, the AC/DC power 814 and the AC/DC power 714 functions as a power source which supplies electric power for control. The AC/DC power 814 receives electric power from the electric power system 12 via the uninterruptible power system 312, for example. The AC/DC power 814 converts alternating current power received from the electric power system 12 into direct current power with appropriate voltage. The AC/DC power 814 supplies the converted direct current power to the CPU board 820.

In the present embodiment, the service outlet 816 supplies electric power to equipment external to the communication unit 126. Examples of the external equipment include the router 314.

The service outlet 816 receives electric power from the electric power system 12 via the uninterruptible power system 312, for example. The service outlet 816 may control the supply of the electric power to the external equipment in accordance with a direction from the CPU board 820. The service outlet 816 may transmit information relating to the electric power supplied to the external equipment to the CPU board 820.

The CPU board 820 controls an operation of each unit of the communication unit 126. The CPU board 820 is connected to the main control board 730 via the communication line 310. The CPU board 820 may function as the control unit 376.

In the present embodiment, the Ethernet interface 830 is connected to the communication network 14 via the router 314. The Ethernet interface 830 may function as the communication interface 128.

In the present embodiment, the NFC reader 842 transmits and receives information to and from the communications terminal 42 through short-range wireless communication. The NFC reader 842 may function as the communication interface 128. The NFC reader 842 may function as the user identification unit 374.

In the present embodiment, the camera 844 captures an image of the user 40. The camera 844 may function as the user interface 372. The camera 844 may function as the user identification unit 374.

In the present embodiment, the touch panel 852 accepts a touch input from the user 40. The touch panel 852 may function as the user interface 372. In the present embodiment, the display 854 presents information to the user 40 by outputting an image. The display 854 may function as the user interface 372. In the present embodiment, the speaker 856 presents information to the user 40 by outputting a voice. The speaker 856 may function as the user interface 372.

The CPU board 820 may be an example of a confirmation apparatus. The touch panel 852 may be an example of the input apparatus described above.

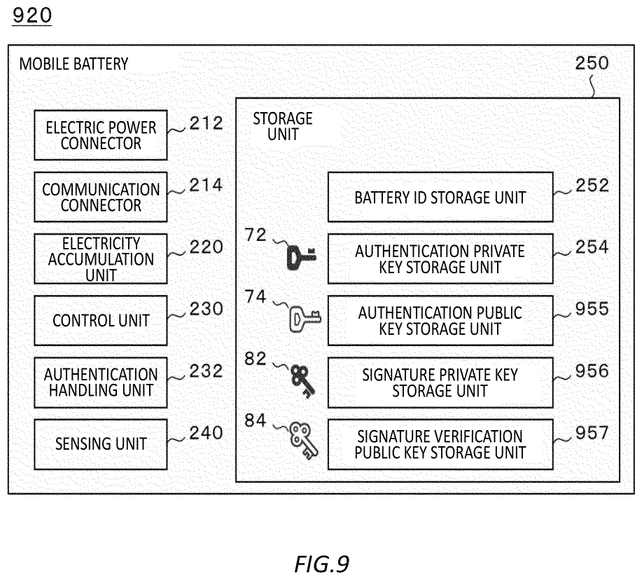

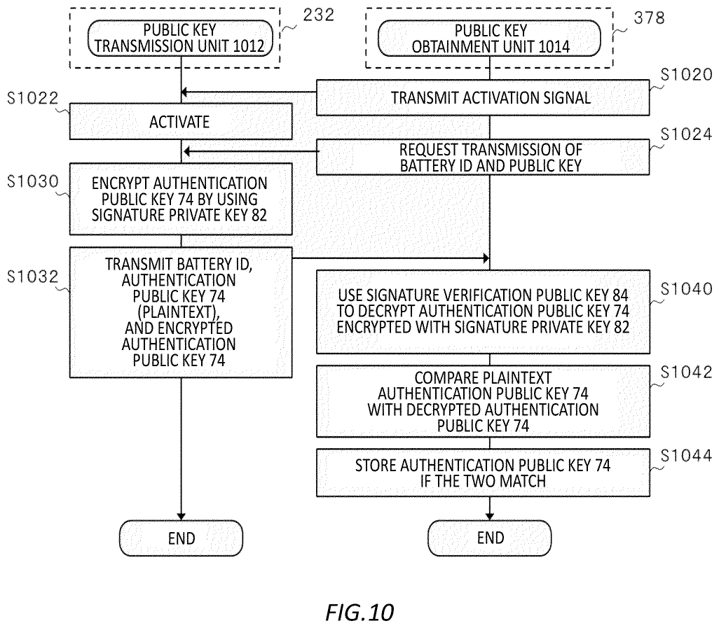

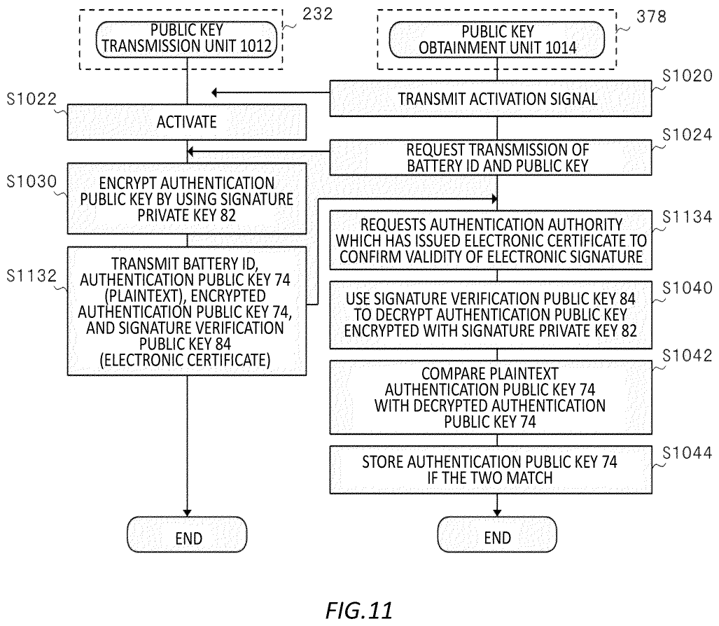

Another example of the procedure for obtaining the authentication public key 74 by the battery station 120 will be described by using FIG. 9, FIG. 10, and FIG. 11. FIG. 9 schematically shows an example of an internal configuration of the mobile battery 920. FIG. 10 schematically shows an example of the procedure for obtaining the authentication public key 74. FIG. 11 schematically shows an example of the procedure for obtaining the authentication public key 74.

In the embodiments described with reference to FIG. 1 to FIG. 6, the battery management system 100 has been described in detail by taking as an example a case where the battery station 120 obtains a database storing the authentication public keys 74 of the one or more mobile batteries 20 from the key issuer 50, the communications terminal 52, or the management server 140. The embodiments to be described with reference to FIG. 9, FIG. 10, and FIG. 11 are different from the embodiments described with reference to FIG. 1 to FIG. 6 in that the battery station 120 obtains, from the mobile battery 20 attached to the slot 124, the authentication public key 74 of that mobile battery 20. With respect to features other than the above-described difference, the embodiments to be described with reference to FIG. 9, FIG. 10, and FIG. 11 may have configurations similar to those of the embodiments described with reference to FIG. 1 to FIG. 6.

As shown in FIG. 9, in the present embodiment, the mobile battery 920 is different from the mobile battery 20 in that the storage unit 250 includes the battery ID storage unit 252, the authentication private key storage unit 254, an authentication public key storage unit 955, a signature private key storage unit 956, and a signature verification public key storage unit 957. With respect to features other than the above-described difference, the mobile battery 920 may have a configuration similar to that of the mobile battery 20. Note that, in the embodiment to be described with reference to FIG. 10, the mobile battery 920 may not include the signature verification public key storage unit 957.

In the present embodiment, the authentication public key storage unit 955 stores the authentication public key 74. In the present embodiment, the signature private key storage unit 956 stores the signature private key 82 used for the mobile battery 20 to give an electronic signature. The signature verification public key storage unit 957 stores the signature verification public key 84 used for the battery station 120 to verify authenticity of the electronic signature of the mobile battery 20. The signature verification public key 84 may be referred to as an electronic certificate.

FIG. 10 schematically shows an example of the procedure for obtaining the authentication public key 74. In the present embodiment, the battery authentication unit 378 has already obtained the signature verification public key 84 of the mobile battery 20 from the key issuer 50, the communications terminal 52, or the management server 140, for example. For example, the storage unit 520 stores a database which associates and stores battery IDs of the one or more mobile batteries 20 and the signature verification public keys 84 of the one or more mobile batteries 20. Note that the signature verification public keys 84 of the plurality of mobile batteries 20 may be the same or the signature verification public keys 84 of all the mobile batteries 20 may be the same.

In the present embodiment, the authentication handling unit 232 further includes a public key transmission unit 1012. In addition, the battery authentication unit 378 further includes a public key obtainment unit 1014.

According to the present embodiment, first, in S 1020, for example, the public key obtainment unit 1014 of the battery station 120 detects that the mobile battery 20 has been attached to the slot 124. When the public key obtainment unit 1014 detects that the mobile battery 20 has been attached to the slot 124, the public key obtainment unit 1014 transmits an activation signal to the mobile battery 20.

In S 1022, for example, when the public key transmission unit 1012 of the mobile battery 20 receives the activation signal, for example, the control unit 230 and the authentication handling unit 232 are activated. At this time, the public key transmission unit 1012 may transmit, to the battery station 120, an activation confirmation signal indicating that the authentication handling unit 232 has been activated.

Next, in S 1024, the public key obtainment unit 1014 transmits, to the mobile battery 20, a signal requesting transmission of a battery ID and the authentication public key 74 (may be referred to as a public key transmission request). In S 1030, for example, when the public key transmission unit 1012 of the mobile battery 20 receives the public key transmission request, the public key transmission unit 1012 encrypts the authentication public key 74 by using the signature private key 82. Then, in S 1032, the public key transmission unit 1012 transmits, to the battery station 120, the battery ID stored in the battery ID storage unit 252, the authentication public key 74 which has not been encrypted, and the authentication public key 74 encrypted with the signature private key 82.

Next, in S 1040, when the public key obtainment unit 1014 receives, from the public key transmission unit 1012, the battery ID, the unencrypted authentication public key 74, and the authentication public key 74 encrypted with the signature private key 82, the public key obtainment unit 1014 refers to the database which associates and stores the battery IDs of the one or more mobile batteries 20 and the signature verification public keys 84 of the one or more mobile batteries 20, to extract the signature verification public key 84 corresponding to the battery ID transmitted by the public key transmission unit 1012. In addition, the public key obtainment unit 1014 uses the extracted signature verification public key 84 to decrypt the authentication public key 74 encrypted with the signature private key 82. Note that, if the signature verification public keys 84 of all the mobile batteries 20 are the same, a step may be omitted in which the public key obtainment unit 1014 refers to the above-described database to extract the signature verification public key 84.

Next, in S 1042, the public key obtainment unit 1014 compares the unencrypted authentication public key 74 transmitted by the public key transmission unit 1012 with the authentication public key 74 decrypted in S 1040. If the unencrypted authentication public key 74 transmitted by the public key transmission unit 1012 matches the authentication public key 74 decrypted in S 1040, in S 1044, the public key obtainment unit 1014 stores the authentication public key 74 transmitted by the public key transmission unit 1012 in the storage unit 520 or the public key database 522 as the authentication public key 74 which is of the mobile battery 20 and is authentic.

The authentication public key 74 may be an example of eleventh information. The signature private key 82 may be an example of twelfth information. The authentication public key 74 encrypted by using the signature private key 82 may be an example of thirteenth information. The signature verification public key 84 may be an example of fourteenth information. The authentication public key 74 decrypted by using the signature verification public key 84 may be an example of fifteenth information.

FIG. 11 schematically shows an example of the procedure for obtaining the authentication public key 74. The procedure for obtaining the authentication public key 74 according to the present embodiment is different from the procedure for obtaining the authentication public key 74 described with reference to FIG. 10 in that S 1132 instead of S 1032 is performed after S 1030 is performed and that S 1134 is performed after S 1132 is performed. With respect to features other than the above-described differences, the procedure for obtaining the authentication public key 74 to be described with reference to FIG. 11 may have a configuration similar to that of the procedure for obtaining the authentication public key 74 described with reference to FIG. 10.

According to the present embodiment, in S 1132, the public key transmission unit 1012 transmits, to the battery station 120, a battery ID stored in the battery ID storage unit 252, the authentication public key 74 which has not been encrypted, the authentication public key 74 encrypted with the signature private key 82, and the signature verification public key 84. In addition, in S 1134, the public key obtainment unit 1014 requests a reliable authentication authority (not shown) to confirm validity or authenticity of the signature verification public key 84. Then, if the validity or the authenticity of the signature verification public key 84 is confirmed, the public key obtainment unit 1014 executes S 1040, S 1042, and S 1044.

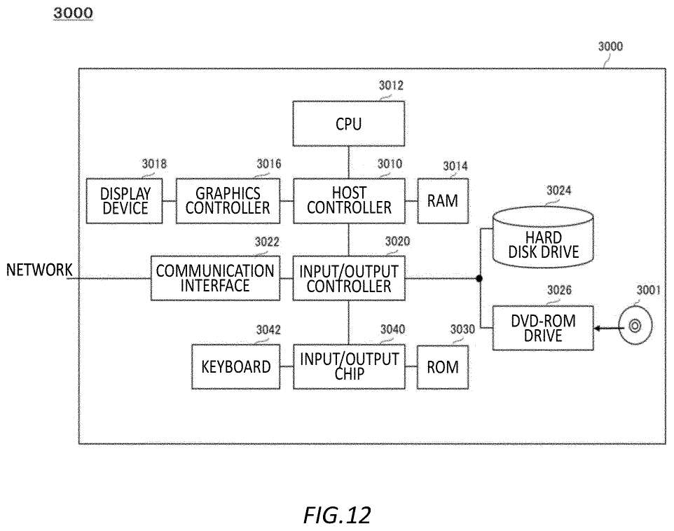

FIG. 12 shows an example of a computer 3000 in which a plurality of aspects of the present invention may be entirely or partly embodied. At least part of the battery management system 100 may be realized by the computer 3000. For example, the control unit 230 or part of it is realized by the computer 3000. For example, the control unit 336 or part of it may be realized by the computer 3000. For example, the control unit 376 or part of it may be realized by the computer 3000.

A program that is installed in the computer 3000 can cause the computer 3000 to perform an operation correlated to an apparatus according to the embodiment of the present invention or to function as one or a plurality of “units” of the apparatus, or cause the computer 3000 to perform the operation or the one or the plurality of “units”, and/or cause the computer 3000 to perform processes according to the embodiment of the present invention or stages of the processes. Such a program may be performed by the CPU 3012 to cause the computer 3000 to perform particular operations correlated to some or all of the blocks of flowcharts and block diagrams described herein.

The computer 3000 in accordance with the present embodiment includes a CPU 3012, a RAM 3014, a GPU 3016, and a display device 3018, which are mutually connected by a host controller 3010. The computer 3000 also includes an input/output unit such as a communication interface 3022, a hard disk drive 3024, a DVD-ROM drive 3026, and an IC card drive, which are connected to the host controller 3010 via the input/output controller 3020. The computer also includes legacy input/output units such as a ROM 3030 and a keyboard 3042, which are connected to the input/output controller 3020 via an input/output chip 3040.

The CPU 3012 operates in accordance with programs stored in the ROM 3030 and the RAM 3014, thereby controlling each unit. The GPU 3016 obtains image data generated by the CPU 3012 on a frame buffer or the like provided in the RAM 3014 or in itself, and causes the image data to be displayed on a display device 3018.

The communication interface 3022 communicates with other electronic devices via a network. The hard disk drive 3024 stores programs and data that are used by the CPU 3012 within the computer 3000. The DVD-ROM drive 3026 reads the programs or the data from the DVD-ROM 3001, and provides the hard disk drive 3024 with the programs or the data via the RAM 3014. The IC card drive reads programs and data from an IC card and/or writes programs and data into the IC card.

The ROM 3030 stores therein a boot program or the like that is performed by the computer 3000 at the time of activation, and/or a program that is dependent on the hardware of the computer 3000. The input/output chip 3040 may also connect various input/output units to the input/output controller 3020 via a parallel port, a serial port, a keyboard port, a mouse port, or the like.

A program is provided by a computer readable storage medium, such as the DVD-ROM 3001 or the IC card. The program is read from the computer readable storage medium, installed into the hard disk drive 3024, RAM 3014, or ROM 3030, which are also examples of computer readable storage medium, and performed by the CPU 3012. The information processing described in these programs is read into the computer 3000, resulting in cooperation between a program and the above-described various types of hardware resources. An apparatus or method may be constituted by realizing the operation or processing of information in accordance with the usage of the computer 3000.

For example, when communication is performed between the computer 3000 and an external device, the CPU 3012 may perform a communication program loaded onto the RAM 3014 to instruct communication processing to the communication interface 3022, based on the processing described in the communication program. The communication interface 3022, under the control of the CPU 3012, reads the transmission data stored in the transmission buffer region provided in the recording medium such as RAM 3014, hard disk drive 3024, DVD-ROM 3001, or IC card, and sends the read transmission data to the network or writes the reception data received from the network to the reception buffer region or the like provided on the recording medium.

In addition, the CPU 3012 may cause all or a necessary portion of a file or a database to be read into the RAM 3014, the file or the database having been stored in an external recording medium such as the hard disk drive 3024, the DVD-ROM drive 3026 (DVD-ROM 3001), the IC card, etc., and perform various types of processing on the data on the RAM 3014. The CPU 3012 may next write back the processed data to the external recording medium.

Various types of information such as various types of programs, data, tables, and databases may be stored in a recording medium and subjected to information processing. The CPU 3012 may perform various types of processing on the data read from the RAM 3014, which includes various types of operations, information processing, condition judging, conditional branch, unconditional branch, search/replacement of information, etc., as described throughout this disclosure and designated by an instruction sequence of programs, and writes the result back to the RAM 3014. In addition, the CPU 3012 may search for information in a file, a database, etc., in the recording medium. For example, when a plurality of entries, each having an attribute value of a first attribute correlated to an attribute value of a second attribute, are stored in the recording medium, the CPU 3012 may search for an entry whose attribute value of the first attribute matches the condition a designated condition, from among the plurality of entries, and read the attribute value of the second attribute stored in the entry, thereby obtaining the attribute value of the second attribute correlated to the first attribute satisfying the predetermined condition.

The above-described program or software modules may be stored in the computer readable storage medium on or near the computer 3000. In addition, a recording medium such as a hard disk or a RAM provided in a server system connected to a dedicated communication network or the Internet can be used as the computer readable storage medium, thereby providing the above-described program to the computer 3000 via the network.

While the present invention has been described by way of the embodiments, the technical scope of the present invention is not limited to the scope described in the above-described embodiments. It is apparent to persons skilled in the art that various alterations or improvements can be made to the above-described embodiments. In addition, the matters described with regard to the particular embodiment can be applied to other embodiments with a range without causing technical contradictions. In addition, each component may have features similar to those of other components which have the same name and have different reference numerals. It is apparent from the description of the claims that embodiments added with such alterations or improvements can also be included in the technical scope of the present invention.

It should be noted that the operations, procedures, steps, stages, and the like of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams for convenience, it does not necessarily mean that the process must be performed in this order.

### EXPLANATION OF REFERENCES

12: electric power system, 14: communication network, 20: mobile battery, 30: electric motorcycle, 40: user, 42: communications terminal, 50: key issuer, 52: communications terminal, 72: authentication private key, 74: authentication public key, 82: signature private key, 84: signature verification public key, 100: battery management system, 120: battery station, 122: preservation unit, 124: slot, 126: communication unit, 128: communication interface, 140: management server, 212: electric power connector, 214: communication connector, 220: electricity accumulation unit, 230: control unit, 232: authentication handling unit, 240: sensing unit, 250: storage unit, 252: battery ID storage unit, 254: authentication private key storage unit, 310: communication line, 312: uninterruptible power system, 314: router, 320: housing, 330: on-board equipment, 332: sensing unit, 334: setting storage unit, 336: control unit, 360: housing, 370: on-board equipment, 372: user interface, 374: user identification unit, 376: control unit, 378: battery authentication unit, 502: authentication code, 504: hash value, 506: hash value, 512: challenge code, 516: response code, 520: storage unit, 522: public key database, 524: whitelist, 530: battery ID obtainment unit, 540: authentication code generation unit, 550: verification code generation unit, 552: hash function, 560: challenge code generation unit, 562: challenge code transmission unit, 570: response code obtainment unit, 582: comparison unit, 584: determination unit, 620: request reception unit, 630: ID transmission unit, 640: challenge code obtainment unit, 650: challenge code decryption unit, 660: response code generation unit, 662: hash function, 670: response code transmission unit, 710: breaker, 712: electric power line, 714: AC/DC power, 716: distributor, 718: electric power line, 730: main control board, 732: communication hub, 734: communication line, 742: temperature regulation unit, 744: buzzer, 746: sensing unit, 748: maintenance door, 760: AC/DC charger, 762: electric power connector, 770: slot control board, 772: communication connector, 774: drive unit, 776: shutter, 778: locking unit, 782: temperature regulation unit, 784: state display unit, 786: sensing unit, 814: AC/DC power, 816: service outlet, 820: CPU board, 830: Ethernet interface, 842: NFC reader, 844: camera, 852: touch panel, 854: display, 856: speaker, 920: mobile battery, 955: authentication public key storage unit, 956: signature private key storage unit, 957: signature verification public key storage unit, 1012: public key transmission unit, 1014: public key obtainment unit, 3000: computer, 3001: DVD-ROM, 3010: host controller, 3012: CPU, 3014: RAM, 3016: GPU, 3018: display device, 3020: input/output controller, 3022: communication interface, 3024: hard disk drive, 3026: DVD-ROM drive, 3030: ROM, 3040: input/output chip, 3042: keyboard.

1. A confirmation method for confirming, by a confirmation apparatus, whether a to-be-confirmed apparatus is a legitimate apparatus, the confirmation method comprising:
converting first information based on second information to generate third information;
transmitting the third information to the to-be-confirmed apparatus;
receiving, from the to-be-confirmed apparatus, (i) fifth information generated through inverse conversion, by the to-be-confirmed apparatus, of the third information based on fourth information paired with the second information or (ii) sixth information generated through information processing, by the to-be-confirmed apparatus, on the fifth information in accordance with a predetermined first algorithm; and
(a) comparing the first information with the fifth information if the fifth information is received, or (b) if the sixth information is received, (i) comparing seventh information to be generated through information processing on the first information in accordance with the first algorithm with the sixth information or (ii) comparing the first information with eighth information to be generated through information processing on the sixth information in accordance with a second algorithm related to the first algorithm.

2. The confirmation method according to claim 1, wherein
the first algorithm is an algorithm relating to arithmetic processing using a first function, or an algorithm relating to encryption processing using a ninth information, and
the second algorithm is an algorithm relating to arithmetic processing using a second function which is an inverse function of the first function, or an algorithm relating to decryption processing using the ninth information or tenth information paired with the ninth information.

3. The confirmation method according to claim 1, further comprising:
(i) obtaining the second information from a manufacturer or a transferor of the confirmation apparatus or from an issuer of the second information and the fourth information or (ii) obtaining the second information from a first external apparatus which is configured to be able to wirelessly communicate with the confirmation apparatus and which has confirmed that the confirmation apparatus is legitimate; and
storing the second information which has been obtained in a first storage apparatus arranged in the confirmation apparatus.

4. The confirmation method according to claim 1, further comprising:
receiving, from the to-be-confirmed apparatus, eleventh information and thirteenth information generated through conversion of the eleventh information based on twelfth information;
comparing fifteenth information to be generated by inversely converting the thirteenth information based on fourteenth information paired with the twelfth information with the eleventh information; and
obtaining the eleventh information as the second information if the eleventh information and the fifteenth information match.

5. The confirmation method according to claim 1, further comprising
determining whether the to-be-confirmed apparatus is the legitimate apparatus, based on a result of comparing the first information and the fifth information, a result of comparing the sixth information and the seventh information, or a result of comparing the first information and the eighth information.

6. The confirmation method according to claim 5, further comprising
confirming that the to-be-confirmed apparatus is not legitimate or that the to-be-confirmed apparatus is illegitimate, if the first information and the fifth information do not match, the sixth information and the seventh information do not match, or the first information and the eighth information do not match.

7. The confirmation method according to claim 1, wherein
the second information is a public key, and
the fourth information is a private key corresponding to the public key.

8. The confirmation method according to claim 1, further comprising:
generating a random number; and
generating the first information based on the random number.

9. The confirmation method according to claim 1, wherein
the to-be-confirmed apparatus includes an electricity accumulation apparatus, and
the confirmation apparatus includes a charging apparatus which is configured to be freely attached to and detached from the electricity accumulation apparatus of the to-be-confirmed apparatus and which charges the electricity accumulation apparatus.

10. The confirmation method according to claim 1, further comprising:
receiving, by the to-be-confirmed apparatus, the third information from the confirmation apparatus;
generating, by the to-be-confirmed apparatus, the fifth information based on the third information and the fourth information; and
transmitting, by the to-be-confirmed apparatus, the fifth information which has been generated to the confirmation apparatus.

11. The confirmation method according to claim 1, further comprising:
(i) obtaining the fourth information from a manufacturer or a transferor of the to-be-confirmed apparatus or from an issuer of the second information and the fourth information or (ii) obtaining the fourth information from a second external apparatus which is configured to be able to wirelessly communicate with the to-be-confirmed apparatus and which has confirmed that the to-be-confirmed apparatus is legitimate; and
storing the fourth information which has been obtained in a second storage apparatus arranged in the to-be-confirmed apparatus.

12. The confirmation method according to claim 4, further comprising:
(i) obtaining the second information and the fourth information from a manufacturer or a transferor of the to-be-confirmed apparatus or from an issuer of the second information and the fourth information or (ii) obtaining the second information and the fourth information from a second external apparatus which is configured to be able to wirelessly communicate with the to-be-confirmed apparatus and which has confirmed that the to-be-confirmed apparatus is legitimate;
converting, based on the twelfth information, the second information which has been obtained, to generate the thirteenth information;
transmitting the thirteenth information which has been generated to the confirmation apparatus; and
transmitting the second information as the eleventh information to the confirmation apparatus.

13. The confirmation method according to claim 1, wherein
the confirmation apparatus is a preservation apparatus which preserves the to-be-confirmed apparatus as a to-be-preserved apparatus, and
the preservation apparatus has an attachment part to which the to-be-preserved apparatus is attached, and
the confirmation method further comprises
deciding not to attach the to-be-preserved apparatus to the attachment part, if the first information and the fifth information do not match, the sixth information and the seventh information do not match, or the first information and the eighth information do not match.

14. The confirmation method according to claim 13, wherein
the preservation apparatus is configured to be able to preserve at least one of a plurality of to-be-preserved apparatuses including the to-be-preserved apparatus,
the confirmation method further comprises:
obtaining joint use identification information for identifying the to-be-preserved apparatus which can be jointly used by a plurality of customers, among the plurality of to-be-preserved apparatuses;
determining whether the to-be-confirmed apparatus is the to-be-preserved apparatus which can be jointly used by the plurality of customers, based on the joint use identification information, if the first information and the fifth information match, the sixth information and the seventh information match, or the first information and the eighth information match; and
deciding not to attach the to-be-preserved apparatus to the attachment part, if it is determined that the to-be-confirmed apparatus is not the to-be-preserved apparatus which can be jointly used by the plurality of customers.

15. The confirmation method according to claim 1, wherein
the confirmation apparatus is a first electric power apparatus having a first terminal, and
the to-be-confirmed apparatus is a second electric power apparatus having a second terminal configured to be able to be attached to the first terminal,
the confirmation method further comprises
deciding to prohibit or suppress output and input of electric power between the first electric power apparatus and the second electric power apparatus, if the first information and the fifth information do not match, the sixth information and the seventh information do not match, or the first information and the eighth information do not match.

16. A confirmation apparatus which confirms whether a to-be-confirmed apparatus is a legitimate apparatus, the confirmation apparatus comprising:
a third information generation unit which converts first information based on second information to generate third information;
a third information transmission unit which transmits the third information to the to-be-confirmed apparatus;
a response reception unit which receives, from the to-be-confirmed apparatus, (i) fifth information generated through inverse conversion, by the to-be-confirmed apparatus, of the third information based on fourth information paired with the second information or (ii) sixth information generated through information processing, by the to-be-confirmed apparatus, on the fifth information in accordance with a predetermined first algorithm; and
a comparison unit which (a) compares the first information with the fifth information if the fifth information is received, or (b) if the sixth information is received, (i) compares seventh information to be generated through information processing on the first information in accordance with the first algorithm with the sixth information or (ii) compares the first information with eighth information to be generated through information processing on the sixth information in accordance with a predetermined second algorithm.

17. An electricity accumulation apparatus comprising:
an electricity accumulation unit which accumulates electrical energy;
an electrical terminal for transmitting and receiving electric power to and from a first electric power apparatus which charges the electricity accumulation unit or uses electric power discharged by the electricity accumulation unit;
a storage unit which stores fourth information;
a third information obtainment unit which obtains third information from the first electric power apparatus;
a fifth information generation unit which generates fifth information by inversely converting the third information obtained by the third information obtainment unit, based on the fourth information stored in the storage unit; and
a response unit which transmits, to the first electric power apparatus, the fifth information, or sixth information to be generated through information processing on the fifth information in accordance with a predetermined first algorithm.

18. A confirmation system comprising:
the electricity accumulation apparatus according to claim 17; and
an electric power apparatus having the confirmation apparatus according to claim 16, wherein
the confirmation apparatus confirms that the electricity accumulation apparatus as a to-be-confirmed apparatus to be confirmed by the confirmation apparatus is a legitimate apparatus.

19. (canceled)

20. A computer readable storage medium having stored thereon a program that causes a computer to execute a confirmation method, wherein,
the confirmation method is a method for confirming, by a confirmation apparatus, whether a to-be-confirmed apparatus is a legitimate apparatus, and
the confirmation method includes:
converting first information based on second information to generate third information;
transmitting the third information to the to-be-confirmed apparatus;
receiving, from the to-be-confirmed apparatus, (i) fifth information generated through inverse conversion, by the to-be-confirmed apparatus, of the third information based on fourth information paired with the second information or (ii) sixth information generated through information processing, by the to-be-confirmed apparatus, on the fifth information in accordance with a predetermined first algorithm; and
(a) comparing the first information with the fifth information if the fifth information is received, or (b) if the sixth information is received, (i) comparing seventh information to be generated through information processing on the first information in accordance with the first algorithm with the sixth information or (ii) comparing the first information with eighth information to be generated through information processing on the sixth information in accordance with a second algorithm related to the first algorithm.

21. The confirmation method according to claim 2, further comprising:
(i) obtaining the second information from a manufacturer or a transferor of the confirmation apparatus or from an issuer of the second information and the fourth information or (ii) obtaining the second information from a first external apparatus which is configured to be able to wirelessly communicate with the confirmation apparatus and which has confirmed that the confirmation apparatus is legitimate; and
storing the second information which has been obtained in a first storage apparatus arranged in the confirmation apparatus.
